(19) United States
(12) Patent Application Publication
(10) Pub. No.: US 2026/0047571 A1
(43) Pub. Date: Feb. 19, 2026

(54) DROP-IN CASSETTE FOR MACHINE PRESERVATION AND TRANSPORTATION OF ORGANS FOR TRANSPLANT

(71) Applicant: NORTHERNMOST MEDICAL DEVICES, INC., Edmonton (CA)

(72) Inventors: Katie Cameron, Edmonton (CA); Steven Cruz Antunes, Edmonton (CA); Chris Sedgwick, Edmonton (CA); Brett Bishop, Edmonton (CA); Joelle Wood, Edmonton (CA); Ryan Baron, Edmonton (CA); Russell Kroll, Atlanta, CA (US); Ben Bailey, Atlanta, GA (US); Francis Garing, Atlanta, GA (US); John Brassil, Lake Mills, WI (US); Ronald Mills, Edmonton (CA); Daniel Salamon, Edmonton (CA)

(21) Appl. No.: 19/304,484

(22) Filed: Aug. 19, 2025

Related U.S. Application Data
(60) Provisional application No. 63/684,715, filed on Aug. 19, 2024.
(60) Provisional application No. 63/828,003, filed on Jun. 21, 2025.

(51) Int. Cl. A01N 1/143; A01N 1/144

(52) U.S. Cl. CPC A01N 1/143; A01N 1/144

(57) ABSTRACT

An apparatus for perfusing and transporting an organ for transplant. The apparatus includes a base, a cassette removably connectable to the base, the cassette including an organ supporting chamber adapted to sterilely store and transport the organ, a cassette interface, and a pump connected to the cassette interface. Responsive to the cassette engaging the cassette interface, the cassette is automatically connected to the pump via the cassette interface and the apparatus is fully operational.

### CROSS-REFERENCE TO RELATED APPLICATIONS

The present application claims the priority benefit of U.S. Provisional Application No. 63/684,715, titled “DROP-IN CASSETTE FOR MACHINE PRESERVATION AND TRANSPORTATION OF KIDNEYS FOR TRANSPLANT,” and filed Aug. 19, 2024, and U.S. Provisional Application No. 63/828,003, titled “DROP-IN CASSETTE FOR MACHINE PRESERVATION AND TRANSPORTATION OF KIDNEYS FOR TRANSPLANT,” and filed Jun. 21, 2025, the entire contents of which are hereby incorporated by reference herein.

### FIELD OF THE DISCLOSURE

The present disclosure generally relates to apparatuses and methods for preserving organs by machine perfusion, and, more particularly, to apparatuses and methods for transporting and perfusing organs in a manner that reduces user setup and operational errors, is cheaper to use, and sturdier to ship.

### BACKGROUND

Organ preservation devices are difficult to set up efficiently and accurately. Known preservation devices employ a base station including a pump deck, a reusable ice chamber positioned in the base station, and a disposable sterile perfusion circuit and organ chamber that nests into the base station adjacent the ice chamber to maintain organ hypothermia during perfusion or failsafe static storage. Securing the disposable sterile perfusion circuit to the pump deck (which is necessary for operation) requires the user to manually perform several tricky connections, which can cause the user to misplace, mishandle, and/or misshape components (e.g., the reusable ice chamber). Deformation of the reusable ice chamber leads to the deterioration of thermal uniformity over the useful life of the reusable components. Moreover, the tricky manual connections tend to lead to tubing leaks and occlusions, create challenges in user training and troubleshooting, and lead to frequent tech support calls, customer complaints, and product returns.

Organ preservation devices are also difficult to transport, particularly via airplane. Currently, organ preservation devices cannot be shipped via commercial cargo, while kidneys preserved by static cold storage are routinely loaded into the cargo hold of the airplane. Cold storage containers must comply with cargo hold regulations. Moreover, according to Organ Procurement and Transplantation Network Policies (OPTN) policies, if an organ is shipped commercially, it must be transported in a new disposable shipping box, and the outer container must have at least 200 pounds of burst strength.

### SUMMARY

In accordance with a first aspect of the present disclosure, an apparatus for perfusing and transporting an organ for transplant is provided. The apparatus includes a base, a cassette removably connectable to the base, the cassette including an organ supporting chamber adapted to sterilely store and transport the organ, a cassette interface, and a pump connected to the cassette interface. Responsive to the cassette engaging the cassette interface, the cassette is automatically connected to the pump via the cassette interface and the apparatus is fully operational.

In accordance with a second aspect of the present disclosure, an apparatus for perfusing and transporting an organ for transplant is provided. The apparatus includes a base including a plurality of electrical components, the plurality of electrical components including one or more sensors, a cassette removably connectable to the base, the cassette including an organ supporting chamber adapted to sterilely store and transport the organ, and a cassette interface. Responsive to the cassette engaging the cassette interface, the cassette is automatically connected to the electrical components via the cassette interface and the apparatus is fully operational.

In accordance with a third aspect of the present disclosure, an apparatus for perfusing and transporting an organ for transplant is provided. The apparatus includes a base, a cassette removably connectable to the base, the cassette including an organ supporting chamber adapted to sterilely store and transport the organ, a cassette interface, and a pump. The pump includes a pump head and a drive motor for the pump head. Responsive to the cassette engaging the cassette interface, the cassette is automatically connected to the drive motor via the cassette interface.

In accordance with a fourth aspect of the present disclosure, an apparatus for perfusing and transporting an organ for transplant is provided. The apparatus includes a portable base, a cassette removably connectable to the portable base, the cassette including an organ supporting chamber and an organ chilling chamber immediately adjacent to the organ supporting chamber, the organ supporting chamber adapted to sterilely store and transport the organ, a cassette interface coupled to the portable base and including a sensor and a conduit, and a pump connected to the cassette interface. The conduit has a first position and a second position, and responsive to movement of the conduit from the first position to the second position, the cassette is operatively connected to the pump via the cassette interface.

In accordance with a fifth aspect of the present disclosure, a reusable and integrated apparatus for perfusing and transporting an organ for transplant is provided. The apparatus includes a base, a presterilized and sealed cassette removably connected to the portable base, the cassette including an organ supporting chamber adapted to sterilely store and transport the organ, a cassette interface carried by the base and/or the cassette, wherein the cassette is thermally and electrically connected to the portable base via the cassette interface, and one or more locking features securing the cassette to the portable base.

### BRIEF DESCRIPTION OF THE DRAWINGS

FIG. 1 is a perspective view of a first example of an organ transportation and perfusion device constructed in accordance with the teachings of the present disclosure, the device including a portable base, a disposable, one-piece cassette removably connected to the portable base, and a lid removably connected to the portable base to secure the cassette within the portable base.

FIG. 2 is a partially exploded view of the organ transportation and perfusion device of FIG. 1.

FIG. 3 is another partially exploded view of the organ transportation and perfusion device of FIG. 1.

FIG. 4 is a cross-sectional view of the disposable cassette of the organ transportation and perfusion device of FIG. 1.

FIG. 5 is a schematic view of the organ transportation and perfusion device of FIG. 1.

FIG. 6 is a perspective view of a second example of the organ transportation and perfusion device constructed in accordance with the teachings of the present disclosure.

FIG. 7 is a perspective view of a third example of the organ transportation and perfusion device constructed in accordance with the teachings of the present disclosure.

FIG. 8 is a perspective view of a lid or cover of the organ transportation and perfusion device of FIG. 7.

FIG. 9 is a cross-sectional view of the lid of FIG. 8.

FIG. 10 is similar to FIG. 7 but shows the lid removed from the rest of the organ transportation and perfusion device.

FIGS. 11A, 11B, and 12 are top perspective views of a base of the organ transportation and perfusion device of FIG. 7.

FIG. 13A is a bottom perspective view of the base of FIGS. 11A, 11B, and 12.

FIG. 13B is similar to FIG. 13A but with various electrical components removed for illustrative purposes.

FIG. 14 depicts the interior of the base of FIGS. 11A, 11B, and 12 as seen from the bottom of the base.

FIG. 15 is a perspective view of a pump of the organ transportation and perfusion device of FIG. 7.

FIG. 16 shows the positioning of the pump of FIG. 15 within the base of the organ transportation and perfusion device of FIG. 7.

FIGS. 17A, 17B, and 17C illustrate how the base of the organ transportation and perfusion device of FIG. 7 is assembled.

FIGS. 18-23 are different views of a drop-in cassette of the organ transportation and perfusion device of FIG. 7.

FIG. 24A is another view of the drop-in cassette, but with particular emphasis on an inline pulse dampening element of the organ transportation and perfusion device of FIG. 7.

FIGS. 24B and 25 are close-up views of the inline pulse dampening element of FIG. 24A.

FIG. 26A is another view of the drop-in cassette, but with particular emphasis on a filter of the organ transportation and perfusion device of FIG. 7.

FIG. 26B is a close-up view of the filter of FIG. 26A.

FIG. 27A is another view of the drop-in cassette, but with particular emphasis on a bubble trap assembly of the organ transportation and perfusion device of FIG. 7.

FIG. 27B is a close-up view of the bottom of the bubble trap assembly of FIG. 27A.

FIG. 27C is a close-up view of the top of the bubble trap assembly of FIG. 27A

FIG. 28A is another view of the drop-in cassette, but with particular emphasis on a drain line and a fluid line of the organ transportation and perfusion device of FIG. 7.

FIGS. 28B and 28C are close-up views of the drain line and the fluid line of FIG. 28A.

FIGS. 29-31 are additional views of the drop-in cassette.

FIG. 32 is a close-up view of a manifold of the drop-in cassette of the organ transportation and perfusion device of FIG. 7.

FIG. 33 is another view of the drop-in cassette.

FIG. 34 is a close-up view of components of the perfusion circuit that are carried by the drop-in cassette.

FIG. 35 illustrates latches and seals that can be used to couple inner and outer lids to the drop-in cassette.

FIGS. 36A and 36B illustrate an electronics board carried by the drop-in cassette.

FIGS. 37A, 37B, and 38 illustrate magnets that can be used to magnetically connect the drop-in cassette to the base of the organ transportation and perfusion device of FIG. 7

FIG. 39 is a partial cross-sectional view showing the engagement between the drop-in cassette and the portable base via the cassette interface.

FIGS. 40 and 41 are different cross-sectional views showing the drop-in cassette coupled to the portable base via the cassette interface.

FIG. 42 is a schematic view of the perfusion circuit of the organ transportation and perfusion device of FIG. 7.

FIG. 43 is a perspective view of a fourth example of the organ transportation and perfusion device constructed in accordance with the teachings of the present disclosure.

FIGS. 44A and 44B illustrate a separate display and a second cover that can be incorporated into any of the first, second, third, and fourth examples of the organ transportation and perfusion device described herein.

### DETAILED DESCRIPTION

The present disclosure is directed to an organ preservation and transportation device that aims to address the above-discussed problems and other problems associated with known organ preservation (or perfusion) devices and that also provides fail-safe cold static storage of a donor organ carried therein during transport. For example, the organ preservation and transportation device disclosed herein is small and compact enough to fit beneath an airplane seat, thereby affording in-cabin accompanied or unaccompanied transit. At the same time, the organ preservation and transportation device disclosed herein is configured to reduce the number of manual connections required to effectively perfuse and transport the donor organ to a transplant center.

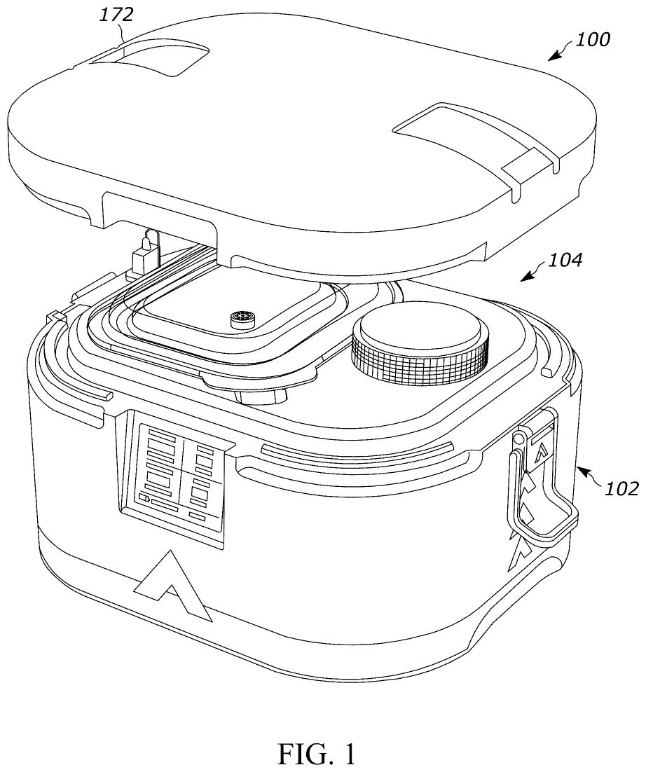

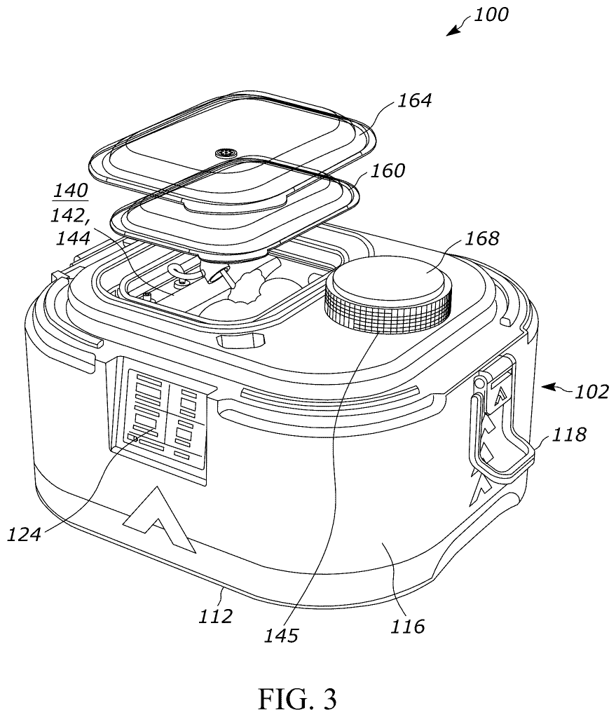

FIGS. 1-5 depict a first example of an organ transportation and perfusion device 100 constructed in accordance with the teachings of the present disclosure. The organ transportation and perfusion device 100 generally includes a base 102, a presterilized cassette 104 removably connectable to the base 102, and a cassette interface 108 through which the cassette 104 may interact with the mechanical, thermal, and electrical components of the base 102 (e.g., the sensors and pumps of the base 102).

The base 102 is configured to be portable, such that the base 102 can be easily and quickly transported between different locations as needed. The base 102 generally includes a bottom wall 112 and a plurality of side walls 116 that are coupled to and extend outward from the bottom wall 112. The bottom wall 112 and the side walls 116 together define a cavity 120 sized to receive the cassette 104. The base 102 also includes a control panel 124 that allows a user to control the mechanical, thermal, and electrical components of the base 102. In this example, the control panel 124 is disposed on one of the side walls 116. The base 102 may include a pair of opposite inset or folding handles 118 connected to an outer shell of the base 102 and configured to allow the user to carry the organ transportation device 100. Preferably, the handles 118 allow for the organ transportation device 100 to be lifted while stacked and transported through a commercial shipper, for example, through cargo hold. The handles 118 are configured to safely bear the load of the organ transportation device 100 and its enclosed contents.

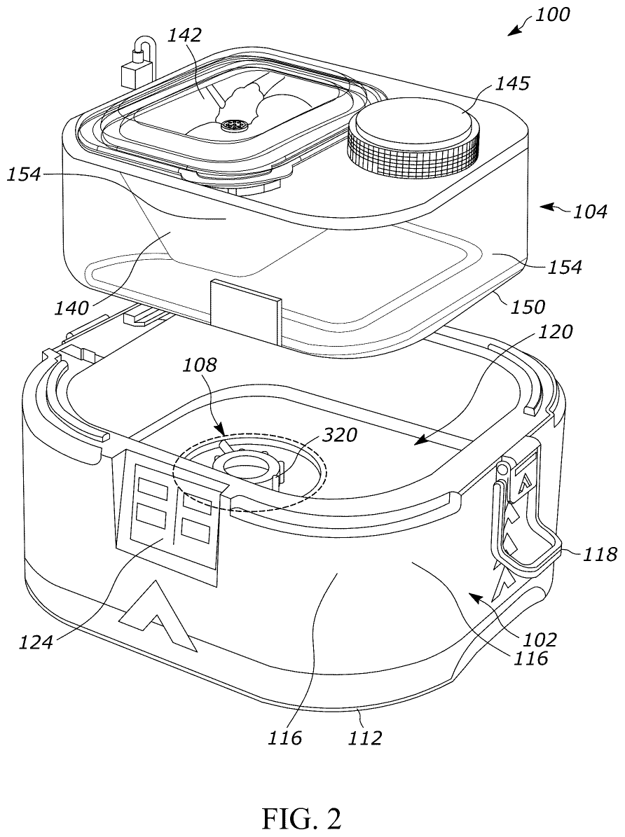

The cassette 104 generally takes the form of a disposable, one-piece cassette that can easily be dropped into or removed from the portable base 102. More particularly, the cassette 104 is configured to be dropped into or removed from the cavity 120 of the base 102. As best shown in FIG. 2, the cassette 104 includes an organ supporting chamber 142 and an organ cooling chamber 145. The cassette 104 has a similar shape as the base 102, such that the cassette 104 also includes a bottom wall 150 and a plurality of side walls 154 coupled to and extending outward from the bottom wall 150. The organ supporting chamber 142 is configured to hold a donor organ (e.g., a kidney) 144 to be perfused and transported. The organ cooling chamber 145 is immediately adjacent to the organ supporting chamber 142 so as to keep the organ supporting chamber 142 (and the donor organ 144) cool. In the present example, the organ cooling chamber 145 at least partially surrounds the organ supporting chamber 142, and a single wall 143 separates the organ supporting chamber 142 and the organ cooling chamber 145, thereby assuring thermal uniformity. In the present example, the device 100 also includes a heat separator 146. In the present example, because the cassette 104 is a one-piece cassette, the organ supporting chamber 142 is permanently (or non-removably) integrated with the organ cooling chamber 145. However, in other examples, the organ supporting chamber 142 may be removable from the organ cooling chamber 145 (and the rest of the cassette 104).

The cassette 104 further includes one or more closure elements for the different chambers of the cassette 104. In this example, the cassette 104 includes a first organ chamber lid 160, a second organ chamber lid 164, and a cap 168 for the organ cooling chamber 145. The first lid 160 serves as the inner lid for the organ supporting chamber 142, whereas the second lid 164 serves as the outer lid for the organ supporting chamber 142. When the first and second lids 160, 164 are coupled to the cassette 104, the first and second lids 160, 164 close or seal the organ supporting chamber 142. Meanwhile, the cap 168 is configured to be coupled to the cassette 104 so as to close or seal the organ cooling chamber 145. In this example, the cap 168 is threadably coupled to an outwardly protruding neck (not shown) of the cassette 104. In other examples, however, the cap 168 can be coupled to the cassette 104 in a different manner.

In some examples, the device 100 can include a lid 172 configured to be coupled to the base 102 to securely close the base 102 (and secure the cassette 104 within the base 102) and seal the device 100 for transport and maximizing insulation of the organ transportation device 100. The lid 172 may be transparent to allow for the organ 144 disposed in the organ supporting chamber 142 to be visually observed. The lid 172 may be manufactured with recyclable materials, such as cork. In some examples, a lid insulation layer 173 may be disposed vertically adjacent to the lid 172. The sealed insulation layer 173 acts to physically protect the cassette 104.

The one or more closure elements may include one or more openings which can be sealed and optionally plugged to maintain sterility and prevent contamination. The one or more openings may, for example, include a biopsy port, which would allow the donor organ 144 to be additionally diagnosed after being removed from the donor, and prior to being transplanted into the recipient. The one or more closure elements may be connected to the cassette 104 in any number of different manners including but not limited to threads, hinges, or magnets, or removable connections. As another example, one or more clasps may be disposed on the one or more closure elements to secure the closure element(s) to the cassette 104.

The cassette 104 also may include an access port for infusing reagents and sampling perfusate 174, with a Luer-activated sterile valve and seal to accommodate aseptic workflows. The cassette 104 may further include a drain port that facilitates the use of tubing to remove organ waste and perfusate 174 from the organ supporting chamber 142 and to allow the perfusion circuit to be safely emptied. Optionally, an overflow trough may be disposed on top of the cassette 104 and may help determine if perfusate 174 is leaking from the inner lid 160. Preferably, the cassette 104 is made of a material (or materials) that is (or are) lightweight to facilitate transportation. Preferably, the cassette 104 is transparent to allow the donor organ 144 disposed therein to be visually observed. The cassette 104 is also preferably manufactured from a durable material.

The organ supporting chamber 142 is partially defined by an organ supporting surface 140 that provides support for the donor organ 144 to be transplanted. In this example, the organ supporting surface 140 is a substantially horizontal chair-like surface that is removably disposed above the bottom wall 150. In other examples, the organ supporting surface 140 can be permanently mounted above the bottom wall 150. Preferably, the organ supporting surface 140 is configured to allow fluid to pass, for example, through perforations formed in the organ supporting surface 140. it will be appreciated that the organ supporting surface 140 can take the form of or can include any of the organ restraint devices discussed in U.S. Provisional Application No. 63/827,559, filed on Jun. 20, 2025, and titled “Restraint Device for Transportation of Organ for Transplant,” the entire contents of which are hereby incorporated by reference herein. Organ debris may be prevented from passing through these perforations through the sizing of the perforations, or through a membrane or filter. The membrane or filter may optionally be made of fabric. An additional membrane or filter may be used to prevent organ debris from entering perfusate tubing.

In operation, a perfusion circuit is needed to maintain the donor organ 144 during storage and transport. Preferably, the perfusion circuit includes a cannula 190 that is coupled to the donor organ 144 to attach a desirably perfused vessel of the organ 144, such as the renal artery in kidneys, to the perfusion circuit. The cannula 190 may be inserted before or after placement of the organ 144 into the organ supporting chamber 142. The cannula 190 can be held in place by a cannula clamp to prevent leaks during perfusion. The cannula 190 and the cannula clamp are preferably adjustable to accommodate variations in arterial size. The cannula 190 may alternatively or additionally be held in place by protrusions, dents, or grooves on the organ supporting surface 140, and the protrusions, dents, or grooves may allow for multiple placements of the cannula 190. Holding the cannula 190 in place helps to prevent shifting that can cause arterial damage. If necessary, multiple cannulas 190 may be attached to the donor organ 144, optionally to perfusate multiple vessels (e.g., arteries) of the donor organ 144, and may allow for multiple perfusates 174. Perfusion is controlled by the control system and is generally based on parameters of the donor organ 144 and/or the organ transportation device 100. The cannula(s) 190 may be single-use or may be reusable. The perfusion circuit can optionally include a bubble detector within the perfusate circuit, for example but not limited to, in the infusion line or the pump output line, to detect the presence of bubbles in the perfusion circuit. The perfusion circuit can alternatively or additionally include a bubble trap that removes bubbles to prevent a blockage within the vasculature of the organ 144.

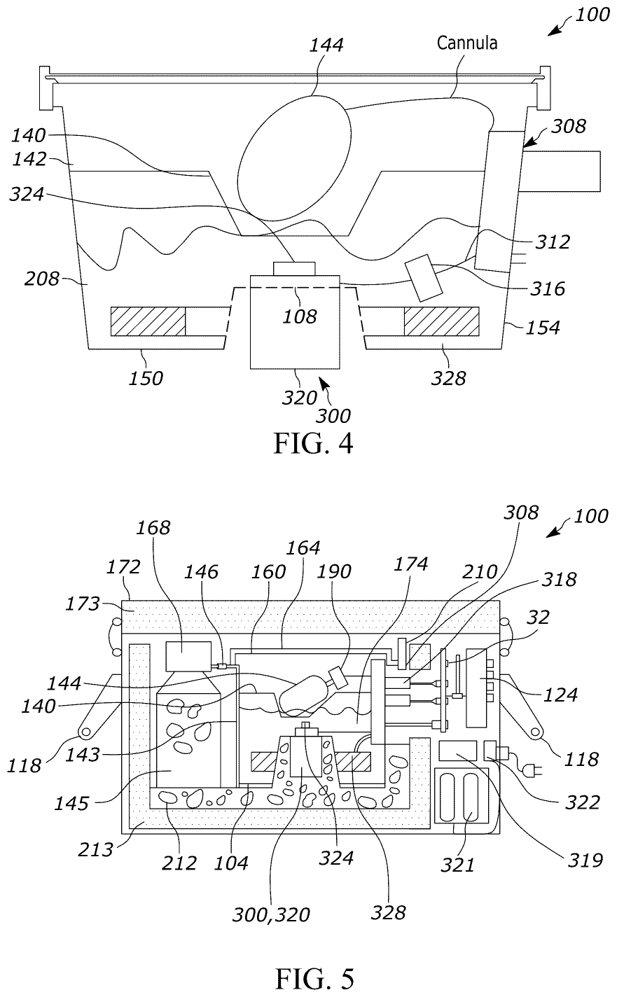

As best illustrated in FIG. 4, the cassette 104 further includes a perfusate chamber 208. In this example, the perfusate chamber 208 is defined between the organ supporting surface 140 and the bottom wall 102, such that the perfusate chamber 208 is immediately adjacent the organ supporting chamber 142 and forms the lowermost volume of the cassette 104. This perfusate chamber 208 may be filled with perfusate 174, and perforations formed in the organ supporting surface 140 may allow the perfusate 174 to contact the outer surface of the donor organ 144. Additionally, the cassette 104 may include a sample port 210 formed in the organ supporting surface 140, along with a Luer-activated sterile valve disposed in the sample port, to draw a fluid sample from the perfusion circuit. This would allow fluid from the venous outflow of the donor organ 144 to be sampled without the necessity to canulate the vein of the donor organ 144, which may cause damage to the vein, and enzymes from the perfusate 174 may be analyzed as necessary to monitor the physiological health of the donor organ 144.

The thermal control system of the organ transportation device 100 is passive and includes the organ cooling chamber 145. In other words, the thermal control system is a cooling system. The organ cooling chamber 145 is configured to house coolant (e.g., ice water), ice, or another cooling substance. Ice has ubiquitous availability for organ transplants, and has a high latent heat capacity, low energy usage, and requires little cleaning and simple disposal. Further, a layer of phase-change material may be inserted in the removable insulated cover and/or beneath the organ cooling chamber 145 and the organ supporting chamber 142. For example, subterranean coolant layer 212 may be employed to supplement passive cooling. A temperature sensor is preferably located in the organ supporting chamber 142 to monitor the temperature of the perfusate 174 within the organ supporting chamber 142. To reduce heat loss to the environment, the organ transportation device 100 may include an insulation layer 213 that is horizontally disposed first between the subterranean coolant layer 212 and the bottom wall 112, is vertically disposed between the organ cooling chamber 145 and one of the sidewalls 116, and is vertically disposed between the organ supporting chamber 142 and the sidewall 116.

The cassette interface 108 is the structural, thermal, electrical, and power transfer interface between the base 102 and the cassette 104. In other words, the cassette interface 108 serves to selectively structurally, thermally, and electrically connect the base 102 and the cassette 104 and to provide power from the base 102 to the cassette 104. The cassette interface 108 therefore simplifies the necessary structural, thermal, electrical, and power connections between the base 102 and the cassette 104. For example, the cassette interface 108 is intended to, for example, replace the pump deck in known preservation machines. The cassette interface 108 generally includes one or more sensors, one or more conduits (e.g., one or more tubes), one or more valves, one or more power supplies, one or more pumping components, one or more seals, one or more manifolds, one or more membranes, and one or more filters, depending upon the exact configuration of the organ transportation and perfusion device 100.

As best illustrated in FIGS. 2 and 4, the cassette interface 108 in this example includes a pump 300, a plurality of sensors 304, a microfluidic manifold 308, fluid conduit 312, a filter 316, a solenoid valve 318, and a power supply 319. In this example, the pump 300 takes the form of a magnetically coupled centrifugal pump having a drive motor 320 and a pump head 324 including an impeller that is driven by the drive motor 320 when magnetically coupled thereto. The drive motor 320 is coupled (e.g., integrally coupled) to the base 102 whereas the pump head 324 is coupled to the cassette 104. For example, the drive motor 320 can be partially enclosed within the base 102 but can partially extend into the cavity 120 from the bottom wall 112 of the base 102, as best illustrated in FIG. 2. In such an example, the pump head 324 can be a disposable pump head that is integrally carried by the bottom wall 150 of the cassette 104, such that the pump head 324 is partially disposed within the perfusate chamber 208. Preferably, the pump head 324 should be sterile to preserve aseptic conditions in the perfusate chamber 208. However, the pump head 324 may be separate from the cassette 104 and may not directly interact with perfusate 174 in order to maintain sterility. Alternatively, the pump 300 can be a peristatic pump or a roller pump. The pump 300 may be pulsatile or continuous and in operation can provide a flow rate between 10 mL/min and 150 mL/min, and a pressure output between 10 mmHg and 65 mmHg. In any event, the pump 300 provides a pressure gradient for the perfusion circuit and facilitates perfusion of the donor organ 144.

The plurality of sensors 304 includes sensors disposed on the bottom wall 112, one or more of the side walls 116, an exterior surface of the bottom wall 150, and/or in or on the microfluidic manifold 308 to collect data about and determine parameters associated with operation of the device 100. The sensors 304 can, for example, include a pressure sensor and a flow sensor (e.g., a heated anemometer, an ultrasonic sensor) disposed in the flow path between the pump 300 and one or more cannulas coupled to the organ 144. Determined parameters can include flow rates (e.g., average flow rates), systolic and diastolic pressures, average pressures, and average vascular resistance. The flow rate can be determined from the speed of the pump 300 and/or from a flow sensor. The average flow rate is calculated as a moving average over a span of a predetermined period of time (e.g., five seconds). The systolic pressure is calculated through an algorithm that detects the local maximum of the pressure waveform, and the diastolic pressure is calculated through an algorithm that detects the local minimum of the pressure waveform. The sensors 304 can alternatively or additionally include a proximity sensor that detects when the cassette 104 is proximate to (or in contact with) the base 102.

In this example, the microfluidic manifold 308 is part of the cassette 104, and, as such, the microfluidic manifold 308 is presterilized and sealed. In this example, the microfluidic manifold 308 can be integrally formed with the cassette 104. More particularly, the microfluidic manifold 308 is integrally coupled to one of the side walls 154 of the cassette 104, as illustrated in FIG. 4. In other cases, the microfluidic manifold 308 can be inserted into or otherwise coupled to the cassette 104 before the cassette 104 is inserted into the cavity 120 of the base 102. In other examples, however, the microfluidic manifold 308 can be disposed (e.g., permanently disposed) within the base 102. It will also be appreciated that the microfluidic manifold 308 can include the pump 300, one or more sensors 304, the fluid conduit 312, the filter 316, the solenoid valve 318, and/or other components.

In this example, the fluid conduit 312, the filter 316, and the solenoid valve 318 are disposed within the base 102. The fluid conduit 312 preferably takes the form of flexible tubing that fluidly connects the microfluidic manifold 308 with the other components of the cassette interface 108, namely the pump head 324. The filter 316, meanwhile, is disposed along the fluid conduit 312 extending between the microfluidic manifold 308 and the pump 324 and is configured to filter out fat, tissue, blood cells, and the like from the perfusate 174. Finally, the solenoid valve 318 is configured to selectively contact the microfluidic manifold 308 to open and close flow channels within the microfluidic manifold 308 by, for example, squeezing against the fluid conduit 312 or other components of the cassette 104.

As shown in FIG. 4, the device 100 optionally includes an oxygenator 328 disposed within the perfusate chamber 208 to exchange oxygen and carbon dioxide in medical fluid flowing to/from the donor organ 144. The oxygenator 328 preferably includes a hydrophobic and oxygen permeable membrane. Depending on the pH of the medical fluid and a viability index calculated based on a plurality of parameters for the donor organ 144, preferably 100% oxygen or a mixture of oxygen and carbon dioxide may be released into the medical fluid by the oxygenator 328. Further details about the oxygenator 328 and the determination of the viability index can be found in, for example, U.S. Pat. No. 9,706,769 (“the '769 Patent”), the entire disclosure of which is incorporated by reference.

The power supply 319 is configured to power the thermal and electrical components of the device 100, namely the control panel 124, the drive motor 320, and the solenoid valve 318. In this example, the power supply 319 includes one or more batteries 321 disposed in a power supply housing formed in the base 102 and/or a power port 322 configured to be connected to an AC or DC power supply. The batteries 321 are preferably reusable. The power supply is also configured to power a microprocessor or a single-board computer 323 disposed in the base 102.

Operation of the device 100 generally begins when the cassette 104 engages the base 102 (and components of the cassette interface 108 coupled to the base 102). More particularly, operation of the device 100 begins when the bottom wall 150 of the cassette 104 engages the bottom wall 112 of the base 102. In this example, the necessary engagement occurs responsive to action by the user, when, for example, the user places or drops the cassette 104 into the cavity 120 of the base 102. Responsive to this engagement, the components of the cassette interface 108 coupled to the cassette 104 are automatically mechanically and electrically connected to the components of the cassette interface 108 coupled to the base 102, such that the device 100 is fully operational. For example, the pump head 324 is automatically and magnetically connected to the drive motor 320 for the pump head 324, the microfluidic manifold 308 is automatically connected to the fluid conduit 312, the filter 316, and the solenoid valve 318, and the sensors 304 are automatically electronically connected to the microprocessor or single board computer. Alternatively, the microfluidic manifold 308 may need to be manually connected to the fluid conduit 312, e.g., by the user, by manipulating the fluid conduit 312 from a first position to a second position, after which the pump head 324 may be automatically and operatively connected to the drive motor 320.

In operation, then, the microprocessor or single board computer 323 receives user inputs (e.g., a target pressure, a target temperature) and receives data from the sensors 304 (and other sensors disposed along the perfusate delivery circuit). In turn, the microprocessor or single board computer 323 can determine parameters about the device 100 and/or the donor organ 144, can instruct the pump 300, the solenoid valve 318, and other components to operate (or change parameters). For example, the microprocessor or the computer 323 may modulate the angular velocity of the pump 300 or impose a pressure profile on the pump 300. The microcontroller or computer 323 may also modulate different flow parameters over different areas of the donor organ 144. In turn, the microprocessor or single board computer 323 may cause the control panel 112 to display information regarding but not limited to the infusion pressure, the infusion temperature, the flow rate, and the bath temperature in the organ cooling chamber 145.

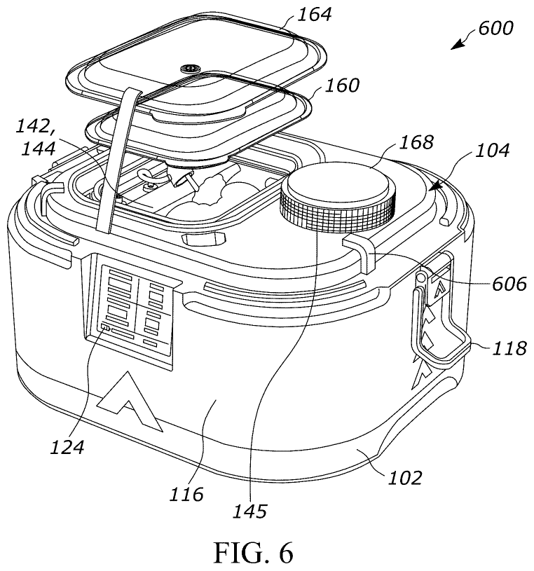

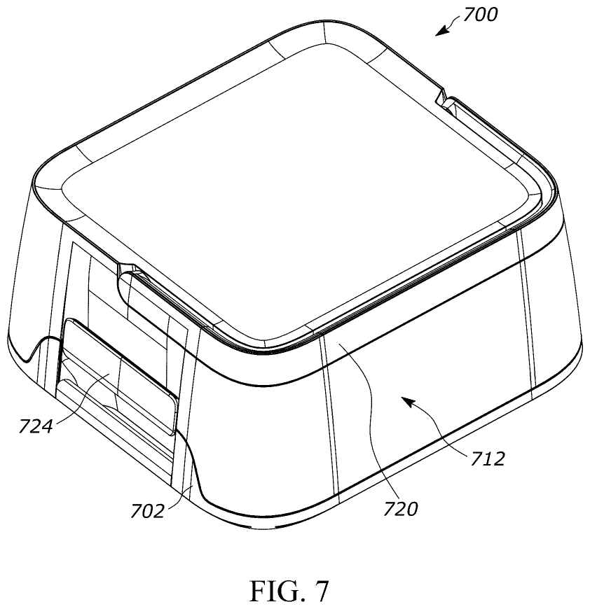

FIG. 6 depicts a second example of an organ transportation and perfusion device 600 constructed in accordance with the teachings of the present disclosure. The device 600 is similar to the device 100, but instead of the user placing the cassette 104 in the base 108 (or removing the cassette 104 from the base 108 following operation), these steps are completed by the manufacturer, rather than by the user. In other words, the cassette 104 of the device 600 is presterilized and sealed, and the organ transportation and perfusion device 600 is an integrated system ready for use on arrival at the organ donation site.

To utilize the integrated transportation and perfusion device 600, the user would unpack the received organ transportation and perfusion device 600, and activate the cooling system of the device 600, for example, through the addition of ice into the chilling chamber 145 of the device 600. Optionally, the user may connect and initiate respiration gas flow. The user would then aseptically access the interior of the cassette 104 of the device 600, insert the donor organ 144 (which may or may not already be cannulated) into the organ supporting chamber, insert perfusate 174 (if not already done so), commence and verify the perfusion circuit priming, connect one or more cannulas to the perfusion circuit and begin perfusion. The system 600 would then be sealed and closed for transport from the organ donation site to a transplant location.

After the organ transportation and perfusion device 600 is transported to the transplant location, the donor organ 144 would be aseptically removed from the cassette 104, and in turn the donor organ 144 is ready to be transplanted. The organ transportation device 600 would in turn be resealed and transported to the manufacturer to be refurbished, recharged, and redeployed into the field. During refurbishment, the cassette 104 may be replaced with a new, sterile cassette 104.

The organ transportation and perfusion device 600 is advantageous, because each organ transportation device 600 is preloaded, secured, and validated to high specifications and tolerances in a factory setting, which thereby increases the efficiency and accuracy of the set-up of the device 600. Indeed, the interface between the heat transfer surfaces may be tightened in the factory setting to a degree not manually achievable by users, therefore enhancing and prolonging the thermal uniformity and cooling life. Economic efficiency and reliability may also be increased as a result of factory assembly of the organ transportation device 600.

Further, and as shown in FIG. 6, the cassette 104 is secured to the base 108 (and the rest of the organ transportation device 600) via one or more tamper-proof, tamper-resistant, or tamper-evident locking features 606. Examples include but are not limited to, security tape, shrink bands, and electronic locking mechanisms that may be used to locally and/or remotely monitor the opening and closing of the device 600.

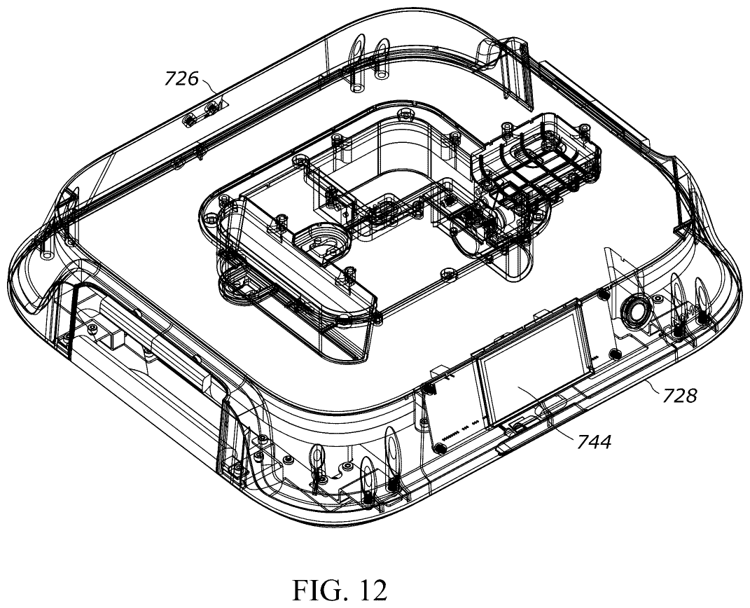

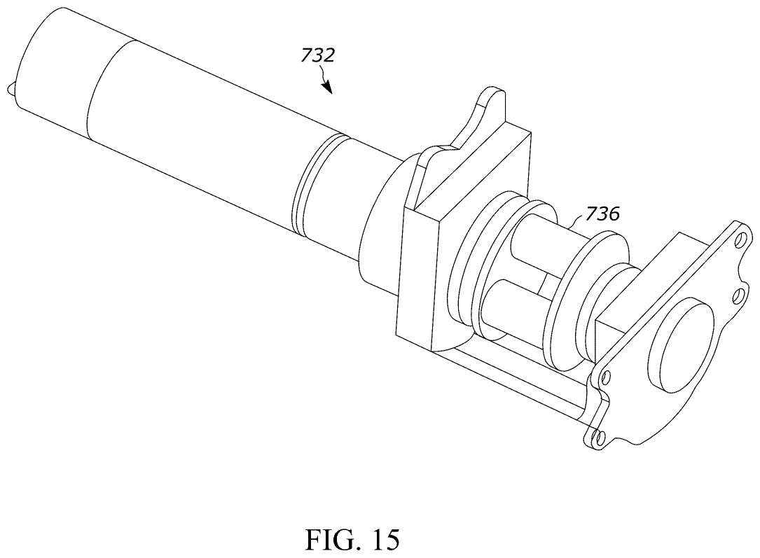

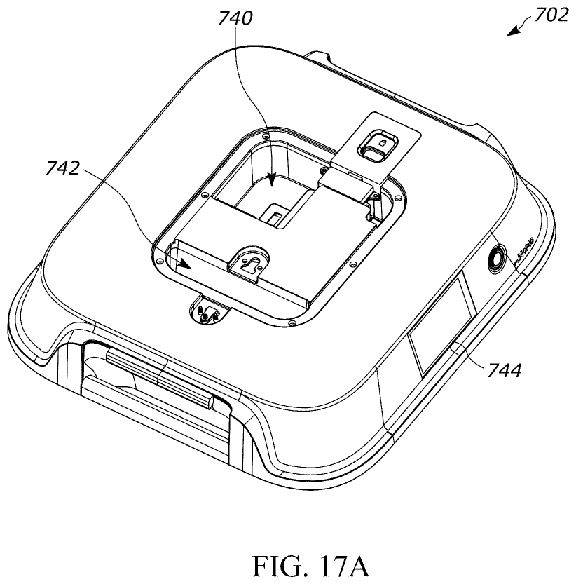

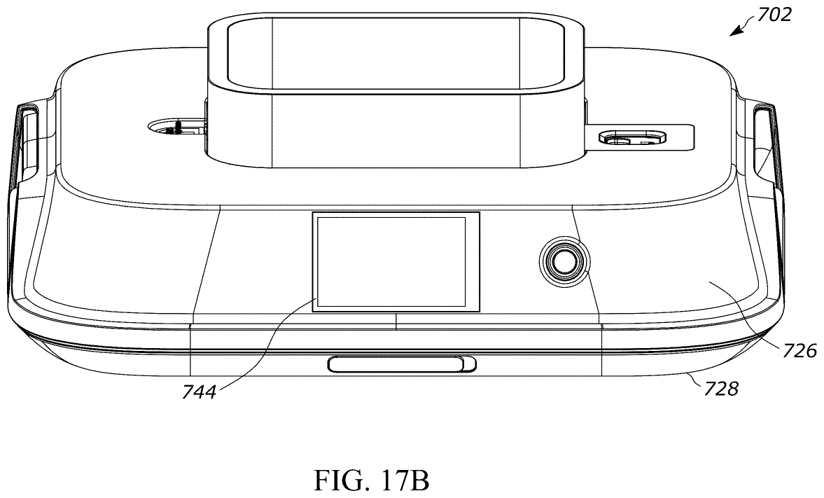

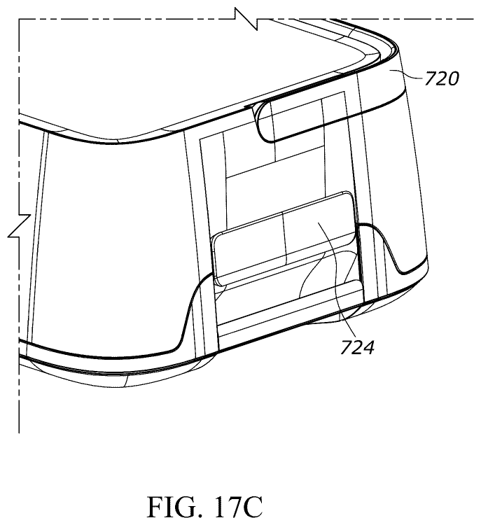

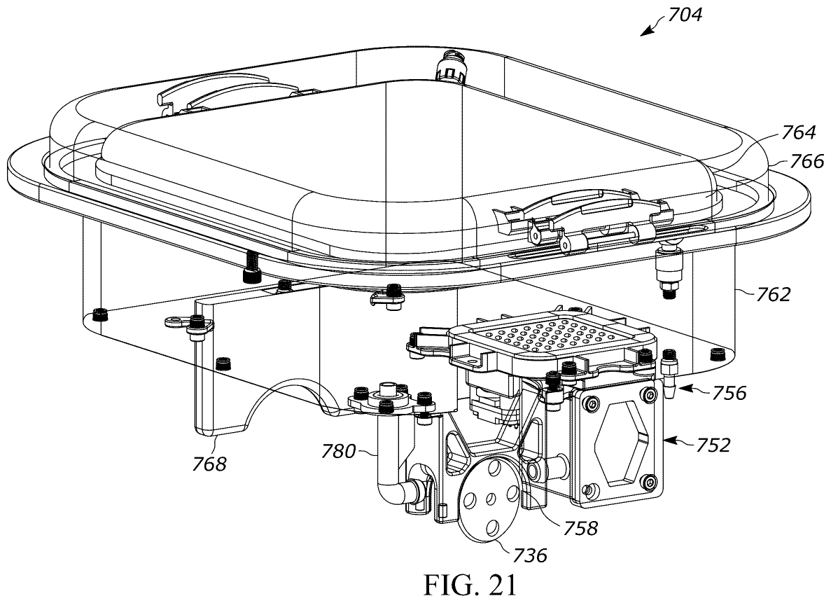

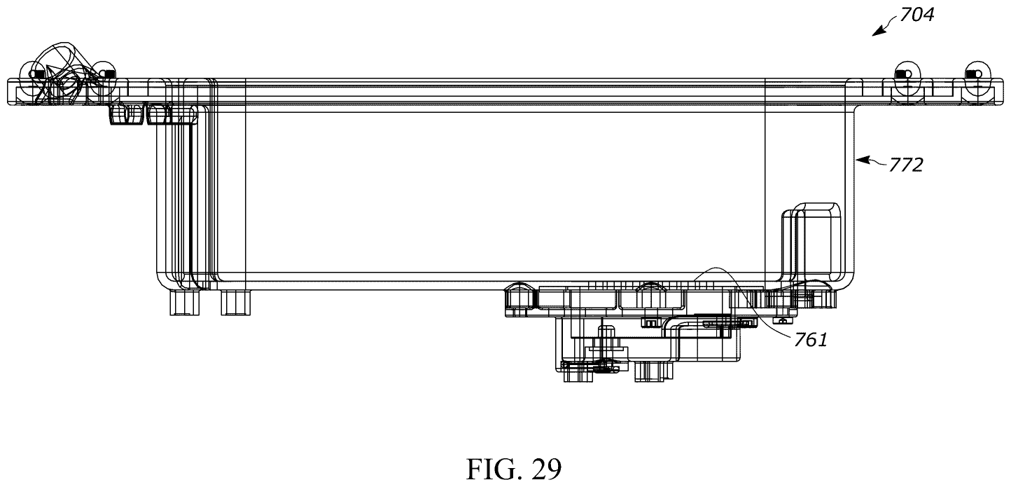

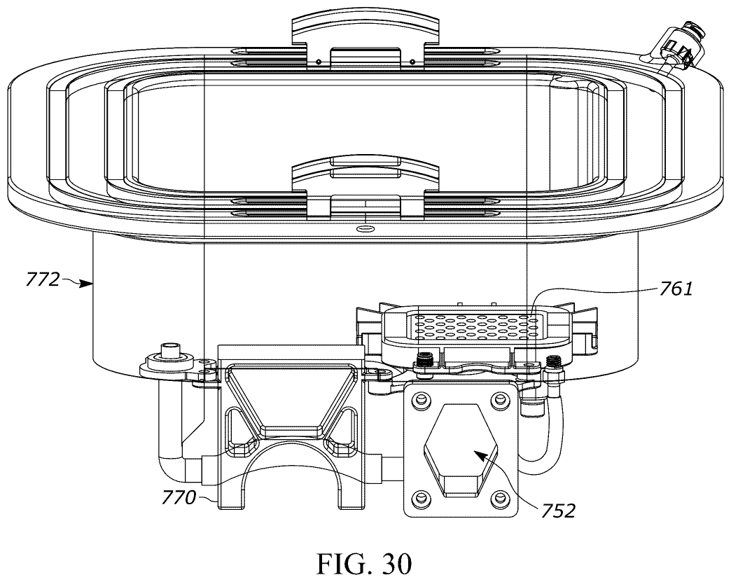

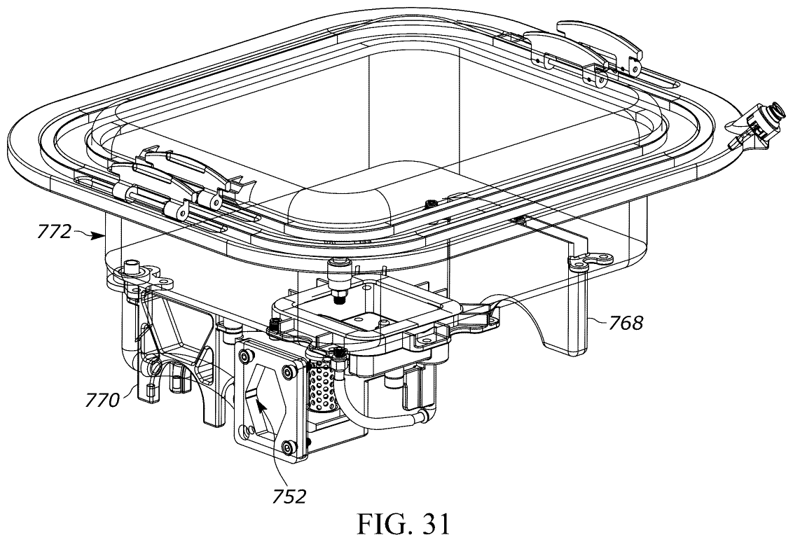

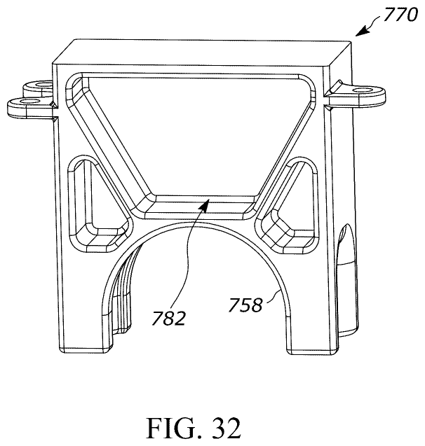

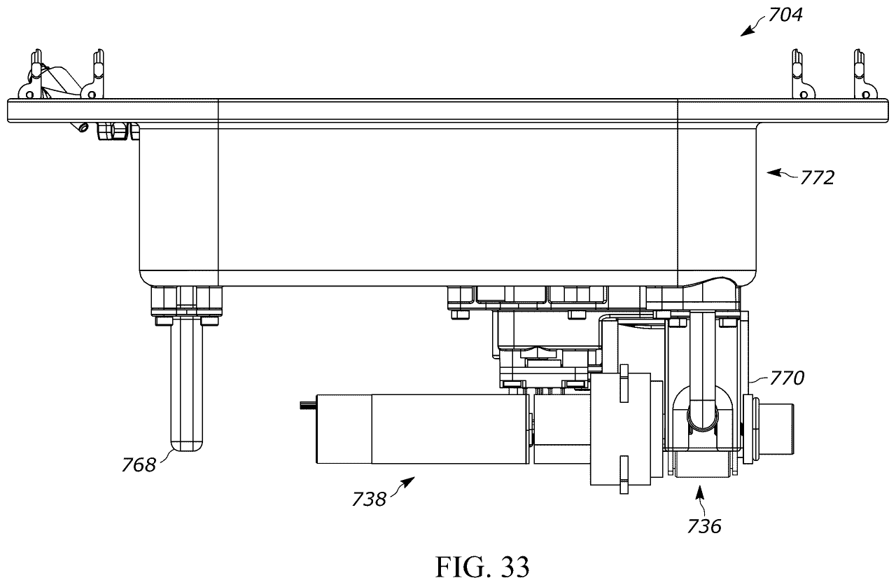

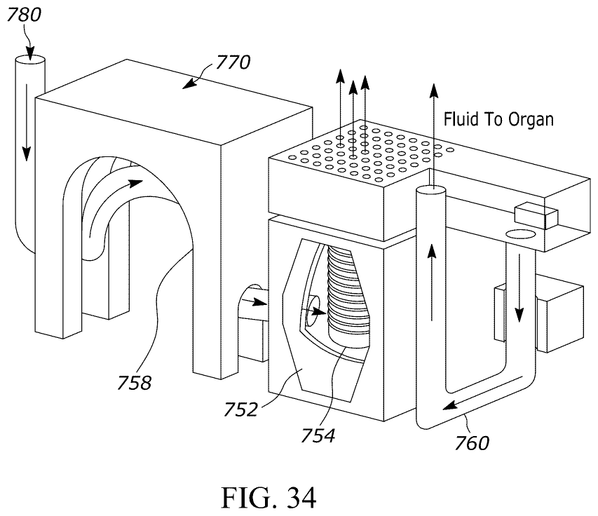

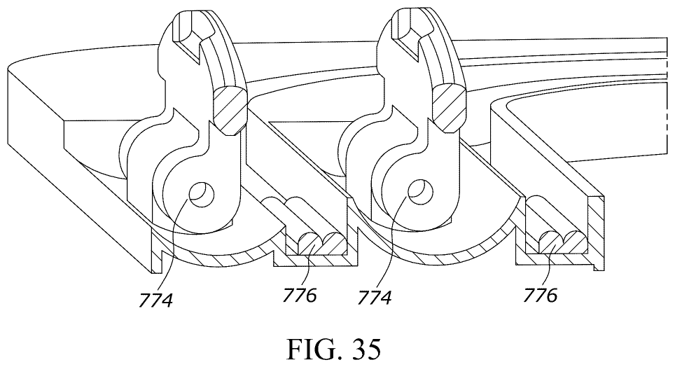

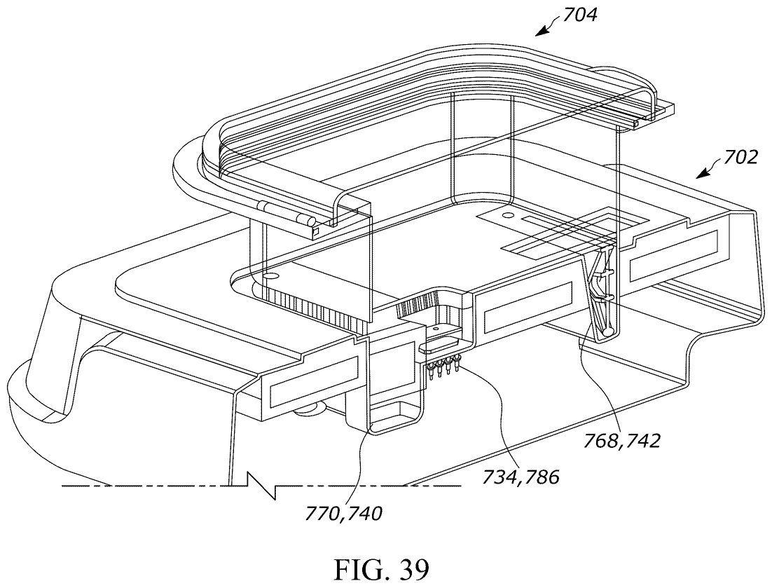

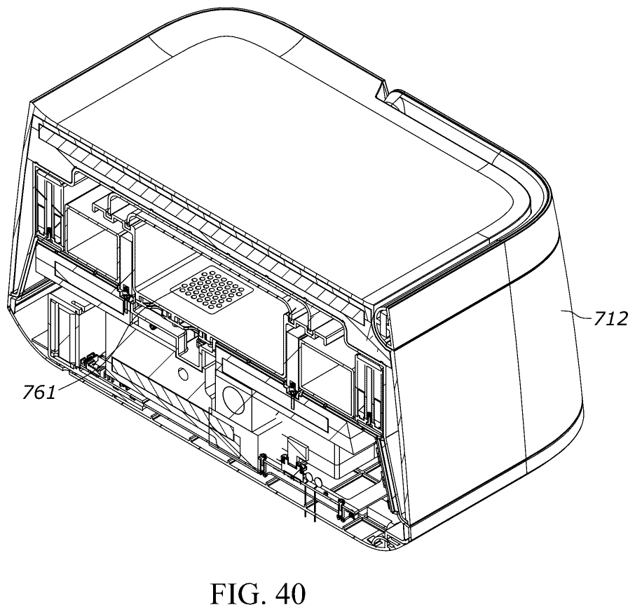

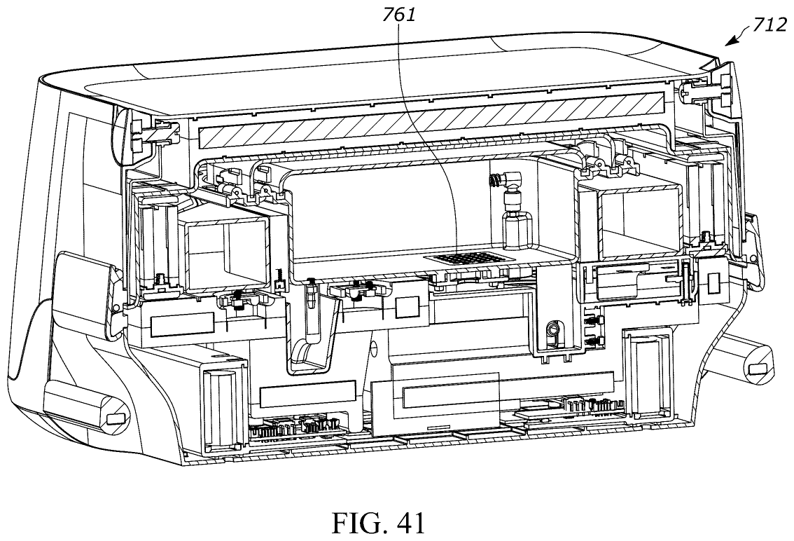

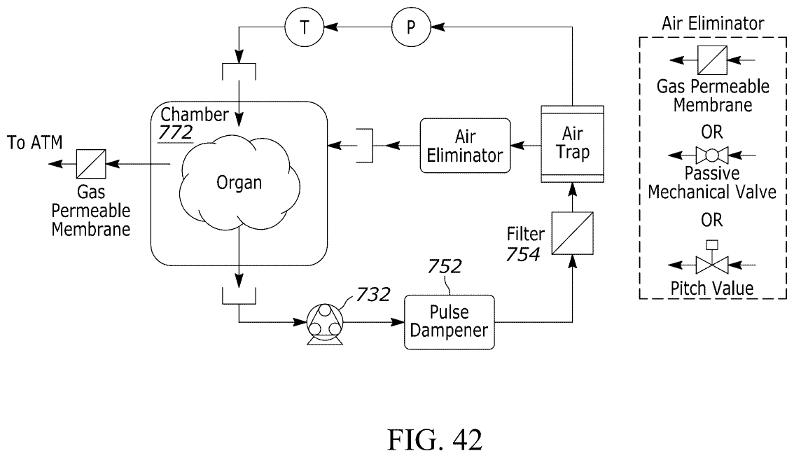

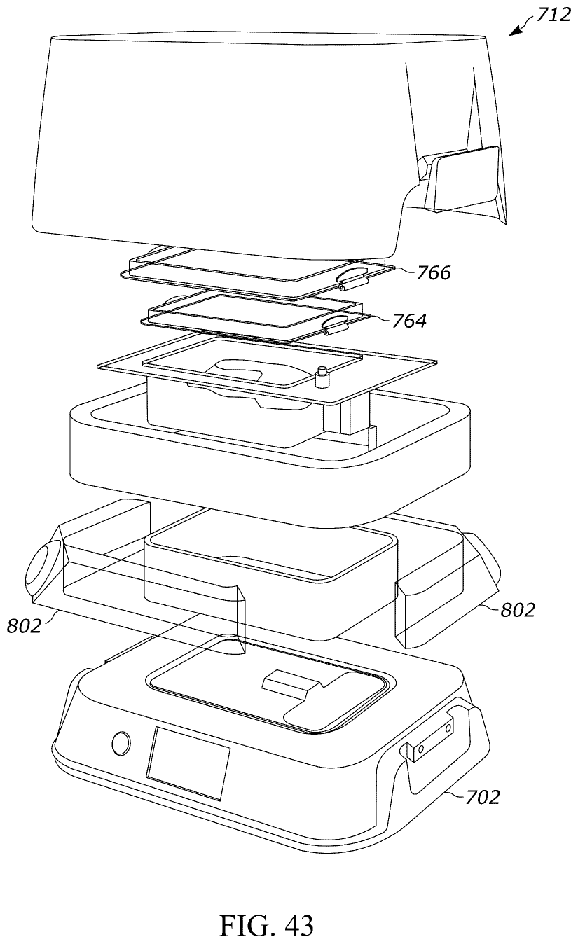

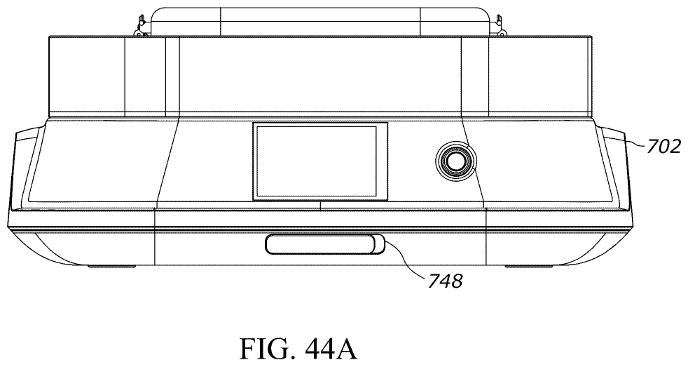

FIGS. 7-42 depict a third example of an organ transportation and perfusion device 700 constructed in accordance with the teachings of the present disclosure. The device 700 is functionally and structurally similar to the device 100, but is different in several ways. More particularly, like the device 100, the device 700 generally includes a base 702, a presterilized cassette 704 removably connectable to the base 702, a cassette interface 708 through which the cassette 704 may mechanically, thermally, and electrically interact with components of the base 702, and a lid (or cover) 712. However, the base 702, the cassette 704, the cassette interface 708, and the lid 712 are different than the base 102, the cassette 104, the interface 108, and the lid 172, respectively, as will be briefly discussed herein and will be appreciated by comparing FIGS. 1-5 to FIGS. 7-43.

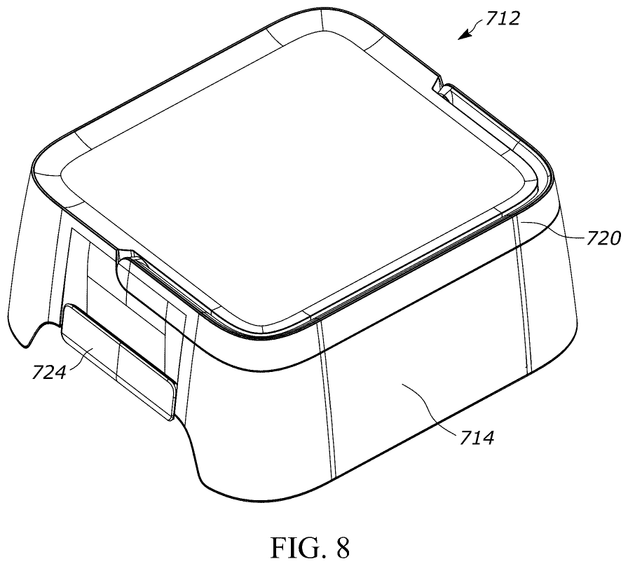

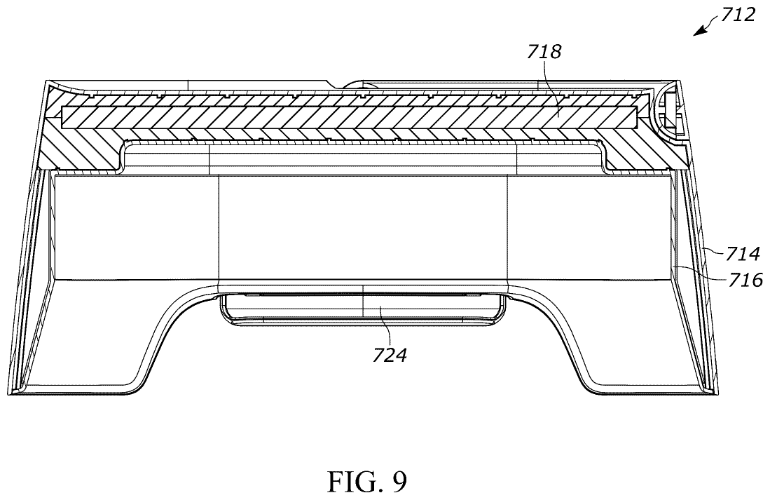

Like the lid 172, the lid 712 is configured to be coupled to the base 702 to securely close the base 702 (and secure the cassette 704 within the base 702) and seal the device 700 for transport and maximizing insulation of the organ transportation device 700. However, the lid 712 in this example substantially surrounds the device 700, such that the lid 712 substantially prevents access (particularly interior access) to the device 700 when coupled to the base 702. As best illustrated in FIGS. 8 and 9, the lid 712 in this example includes an outer shell 714, an inner shell 716, and an insulation stack 718. The inner shell 716 is coupled to the outer shell 714 (e.g., via a plurality of flanges carried by the inner shell 716 and inserted into a plurality of recesses formed in the outer shell 714). The insulation stack 716, meanwhile, is sandwiched between the outer shell 714 and the inner shell 716 and includes one or more insulation layers. So positioned, the insulation layer(s) of the insulation stack 716 act(s) to physically protect the cassette 704 and to thermally isolate the outer shell 714 from the interior of the device 700 (and vice-versa). In other examples, however, the lid 712 may only include a single shell or may include two or more outer shells and/or two or more inner shells. In these other examples, the lid 712 will preferably still include one or more insulation layers.

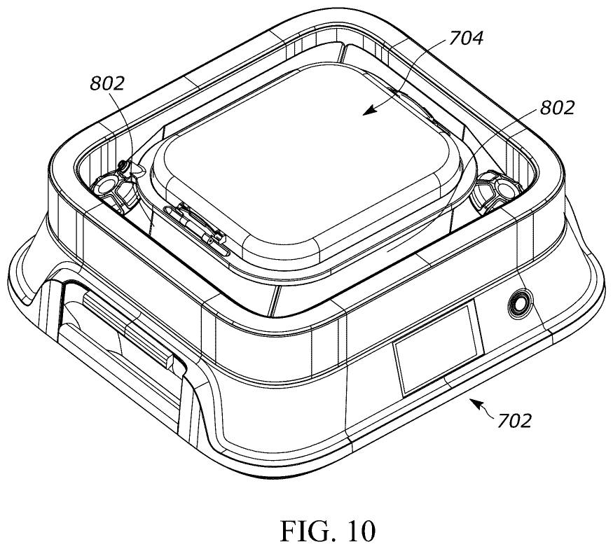

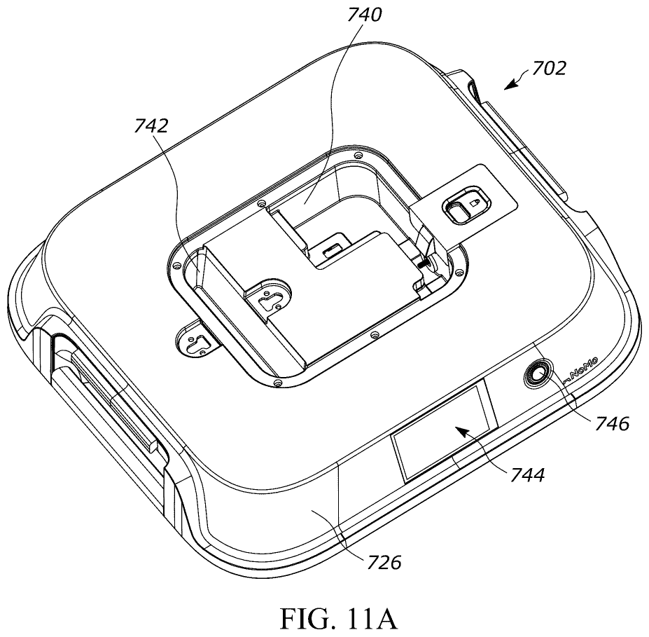

The device 700 may, in some examples, include a handle 720 that allows a user to lift and/or carry the organ transportation device 700. In this example, the handle 720 is rotatably coupled to the lid 712 between a first, storage position (shown in FIGS. 7 and 8) and a second, in-use position (not shown). In the first position, the handle 720 is disposed within a recess formed in the outer shell 714 such that the handle 720 surrounds a portion of the lid 712 and does not protrude outward from the outer shell 714. In the second position, a portion (e.g., the middle) of the handle 720 is spaced from the lid 712, which thereby allows the user to grip the handle 720 and lift and/or carry the device 700 as needed. Alternatively or additionally, the device 700 may include a pair of latches 724 that allow a user to carry the organ transportation device 700 and help to secure the lid 712 to the base 702. In this example, the latches 724 are disposed on opposite sides of the device 700, with one part of each latch 724 fixed to the outer shell 714 of the lid 712 and the other part of each latch 724 removably securable to a portion of the base 702. As a result, the latches 724 are exposed at all times and allow the user of the device 700 to lift and/or carry the device 700 as needed. At the same time, the latches 724 can be quickly and easily removed by disconnecting the latches 724 from the base 702, thereby allowing the user to remove the lid 712 and access the base 702 and the cassette 704, as is illustrated in FIG. 10.

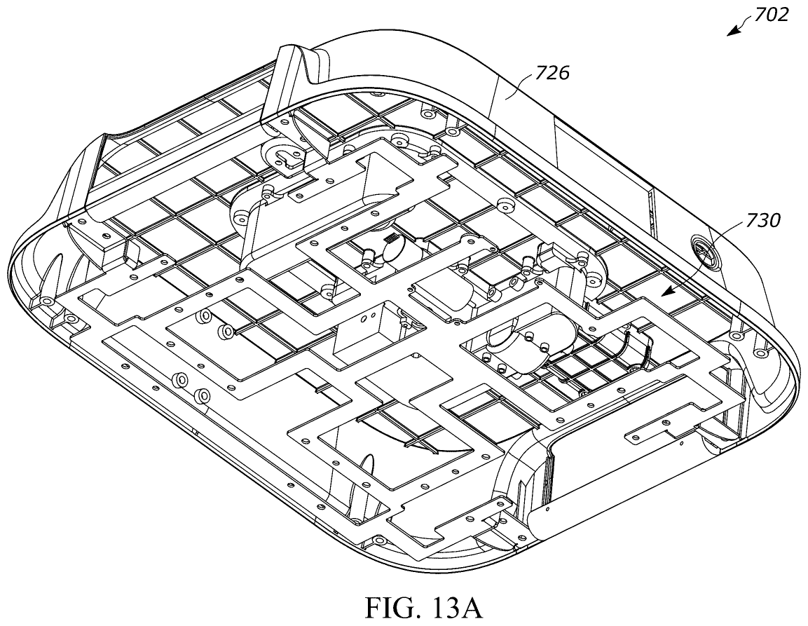

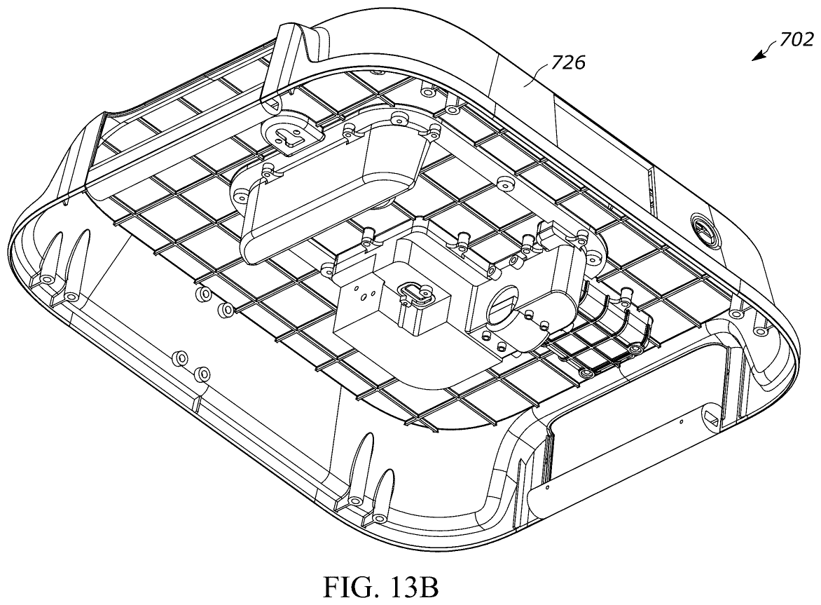

Like the base 102, the base 702 is configured to be compact and portable, such that the base 702 can be easily and quickly transported between different locations as needed. However, unlike the base 102, the base 702 generally includes a base tub 726 and a base panel 728 coupled to the base tub 726. The base panel 728 defines the bottom of the device 700, and the base tub 726 and the base panel 728 together define a base cavity 730 (see FIGS. 13A and 13B) that houses various mechanical and electrical components, including, for example, a pump 732, one or more sensors (e.g., temperature sensors, flow sensors, pressure sensors), an electronics interface 734, various circuit boards, a power supply like the power supply 319 described above, and connecting wires (as needed). The pump 732 in this example takes the form of a peristaltic pump that includes a pump head 736 and a drive motor 738 for the pump head 736. The pump head 736 in this example is a four-roller pump head, though in other examples, the pump head 736 may include more or less rollers. Meanwhile, the electronics interface 734 takes the form of an electronics board sized to receive a plurality of pins from the cassette 704 to mechanically and electrically connect the cassette 704 and the base 702 (and vice-versa).

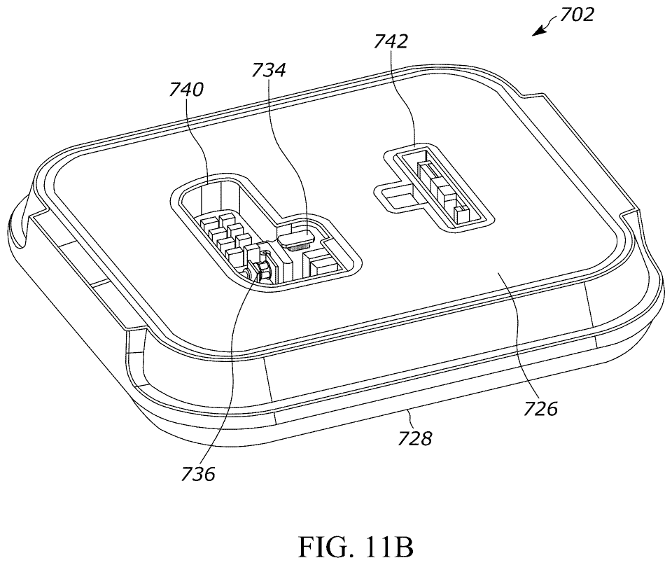

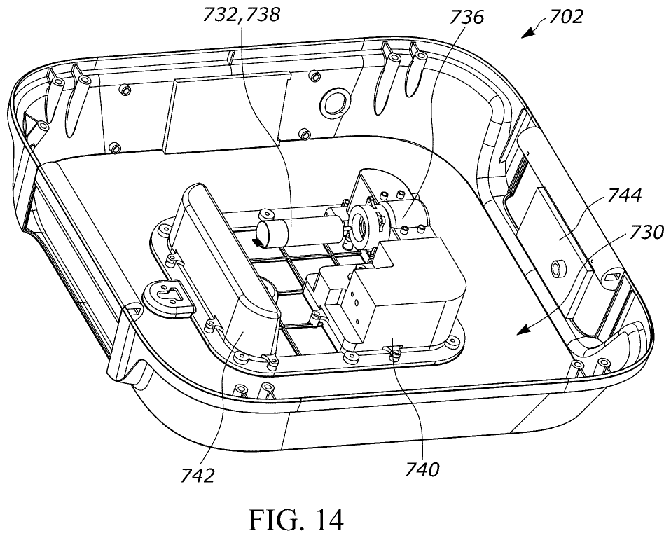

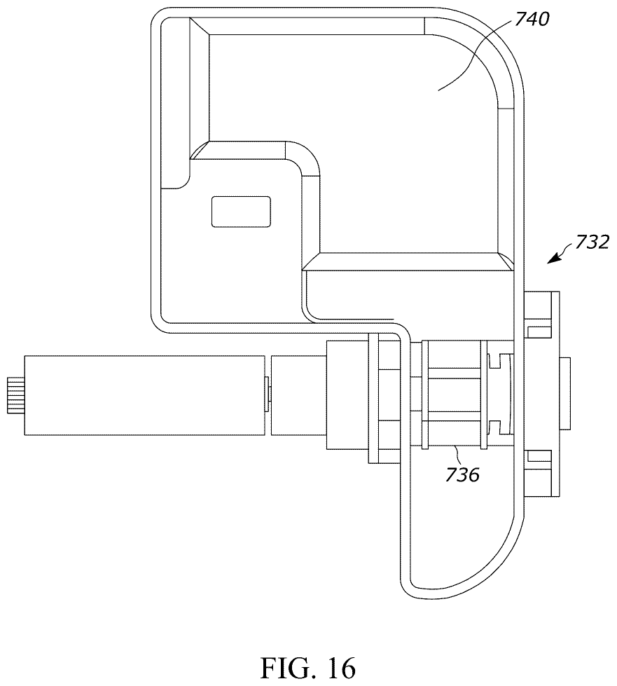

As best illustrated in FIGS. 11A, 11B, and 14, the base 702 also includes a pair of pockets—a manifold pocket 740 and a foot pocket 742—that together (at least partially) define the cassette interface 708 for the cassette 704. Each of the pockets 740, 742 is formed in the base tub 726 and exposes a portion of the interior of the base cavity 730. More particularly, the pump 732 is positioned so that the pump head 736 is disposed in and visible via the manifold pocket 740 (see FIG. 16), such that the cassette 704 can be quickly and easily connected to or disconnected from the pump 732 via the manifold pocket 740. Likewise, the electronics interface 734 is disposed in and visible via the manifold pocket 740, such that the cassette 704 can be quickly and easily connected to or disconnected from the electronics interface 734.

The base 702 also includes a control panel 744 that preferably includes or provides a primary user interface (e.g., a touch screen) that allows the user to control the mechanical, thermal, and electrical components of the device 700. In this example, the control panel 744 is disposed on one of the side walls of the base tub 726. In some examples, the primary user interface may output (e.g., visually display or audibly output) one or more alarms for the user of the device 700. For example, the primary user interface may output an alarm when the temperature of the donor organ and/or an organ supporting chamber 772 is too high or low, when occlusion has occurred, when the device 700 determines that the donor organ is not properly connected, when the power supply includes batteries and the battery level is low, or for some other reason. It will, however, be appreciated that while these alarms are meaningful to certain users (e.g., clinical and administrative users), the recognition and observation of these alarms by other users (e.g., public passersby and other untrained users) is unnecessary and potentially counterproductive or unsafe, particularly if these alarms lead such users to interfere with the device 700 (e.g., by accidently pushing buttons). Therefore, these alarms may only be output when the lid 712 is removed from the base 702. Moreover, the control panel 744 is located so as to be selectively accessible based on the likely use of the device 700. More particularly, when the donor organ is being transported via the device 700 (and the lid 712 is coupled to the base 702), the control panel 744 is located under the lid 712, such that the control panel 744 is not visible and any alarms displayed by the primary user interface are not accessible by the user. In other words, when the lid 712 is on, no electronic interface is visible to the user. Conversely, when the lid 712 is removed from the base 702 (and the user likely has authorized access), the control panel 744 is visible, such that the alarms output by the primary user interface are accessible by the user. Similarly, while not specifically illustrated herein, the controls of the device 700 (e.g., power button 746) may only be accessible to the user when the lid 712 is removed from the base 702 (and the user likely has authorized access). For example, the power button 746 of the device 700 may be disposed on the base 702 so as to only be accessible when the lid 712 is removed from the base 702, as is illustrated in FIG. 11A.

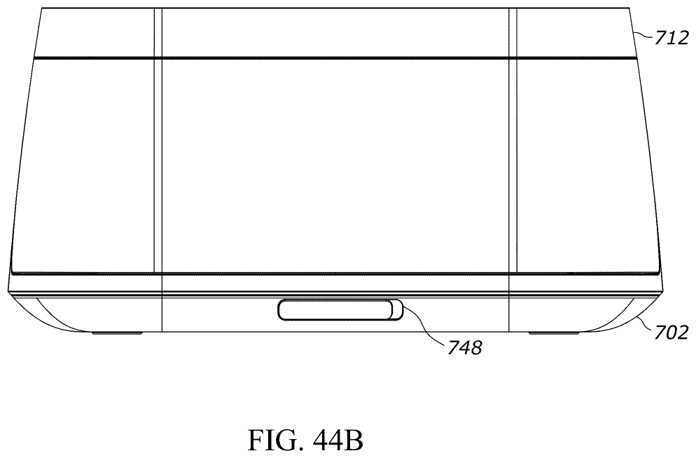

In other examples, such as the example illustrated in FIGS. 44A and 44B, the device 700 can include a separate display 748 on the base 702 that is not hidden by the lid 712, regardless of whether the lid 712 is or is not coupled to the base 702. This display 748 can, for example, visually display the operational status of the device 700 and/or any of the alarms described above. In one example, the display 748 can include a light-emitting diode that is powered on or powered off (or changes colors) based on the operational status of the device 700. In some examples, such as the example illustrated in FIGS. 44A and 44B, the device 700 can include a second cover for this separate display. The second cover can be removably coupled to the separate display, such that the second cover can be removed and the display 748 exposed as needed.

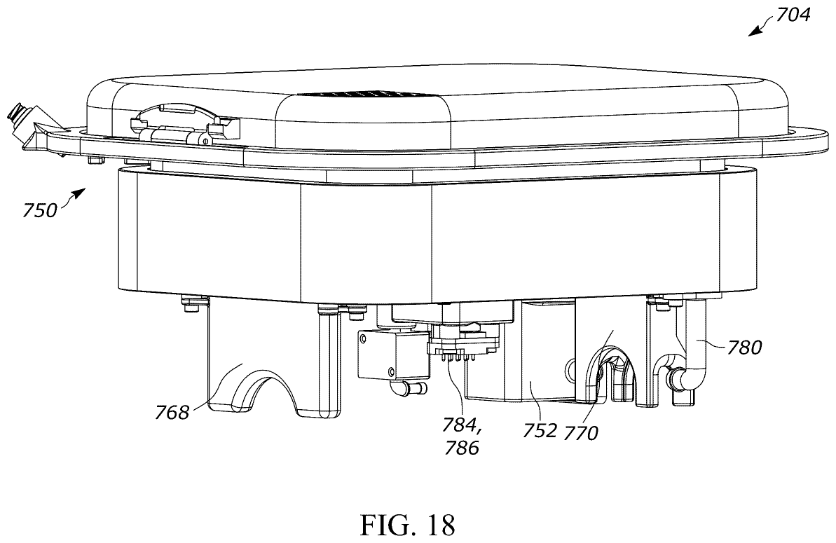

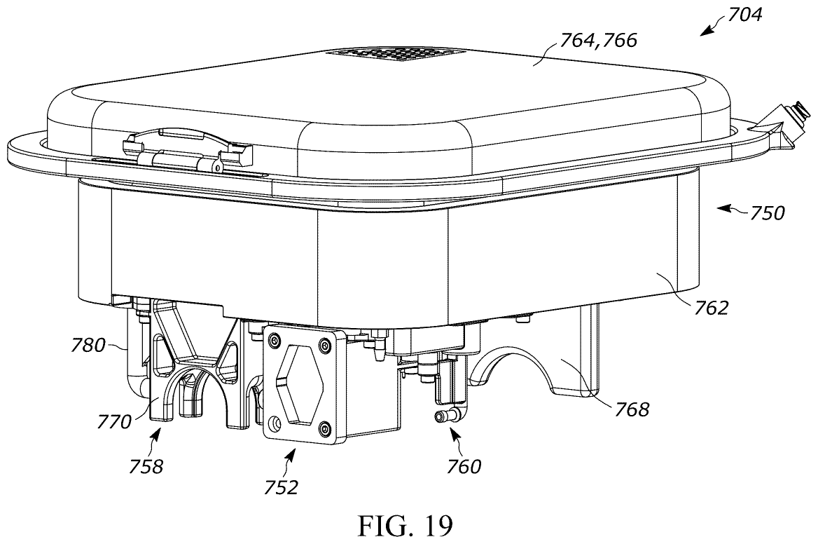

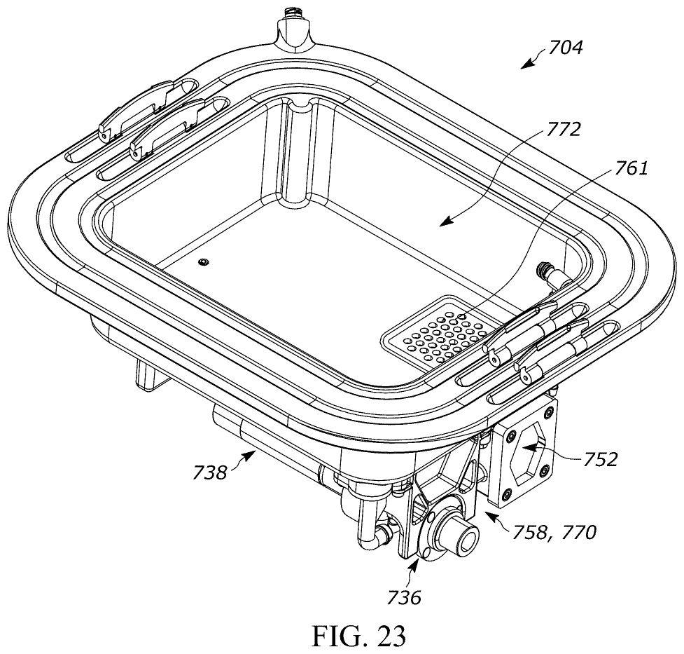

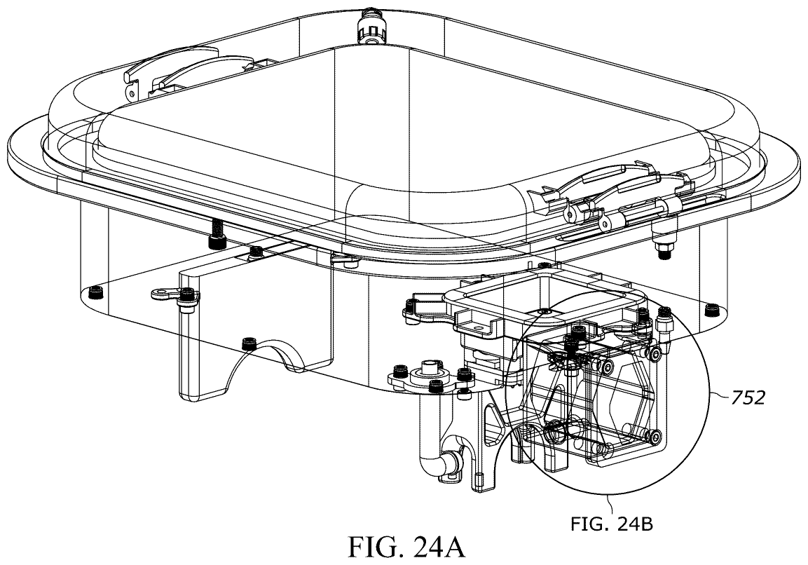

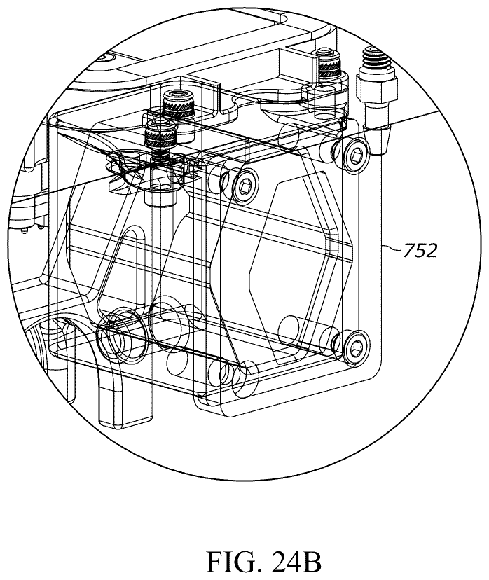

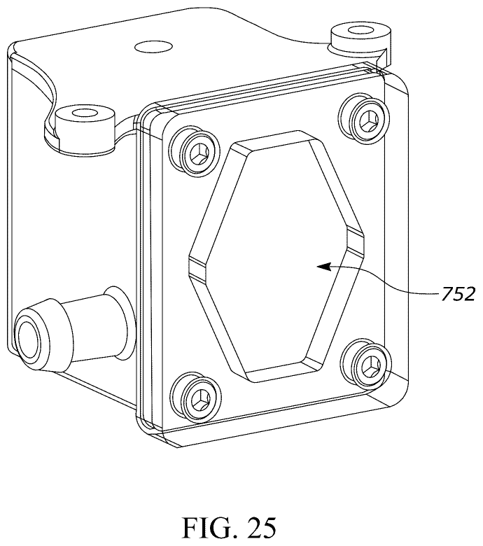

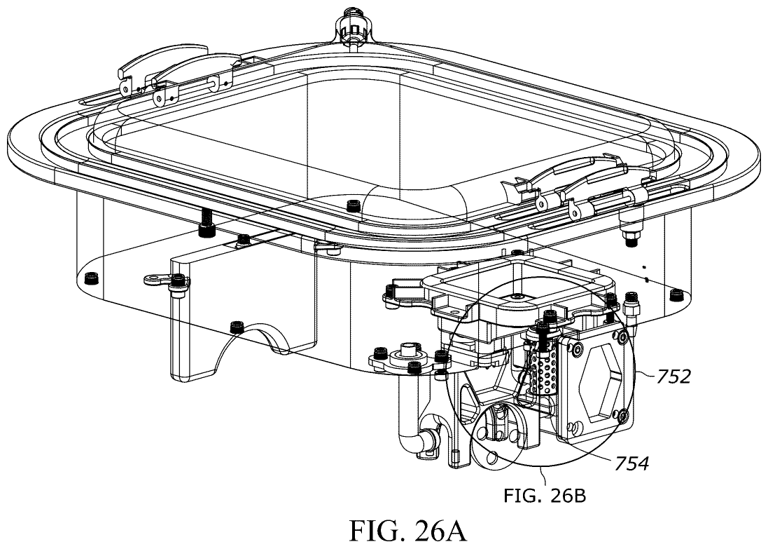

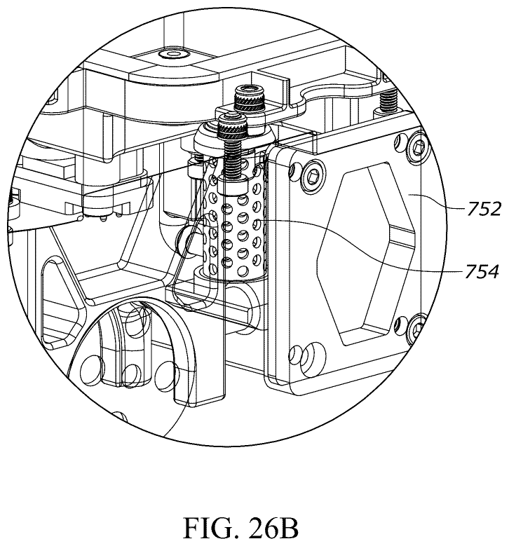

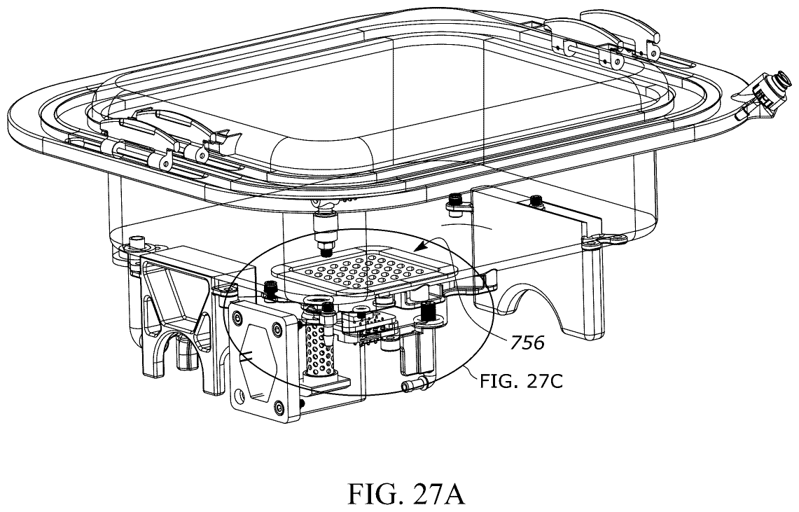

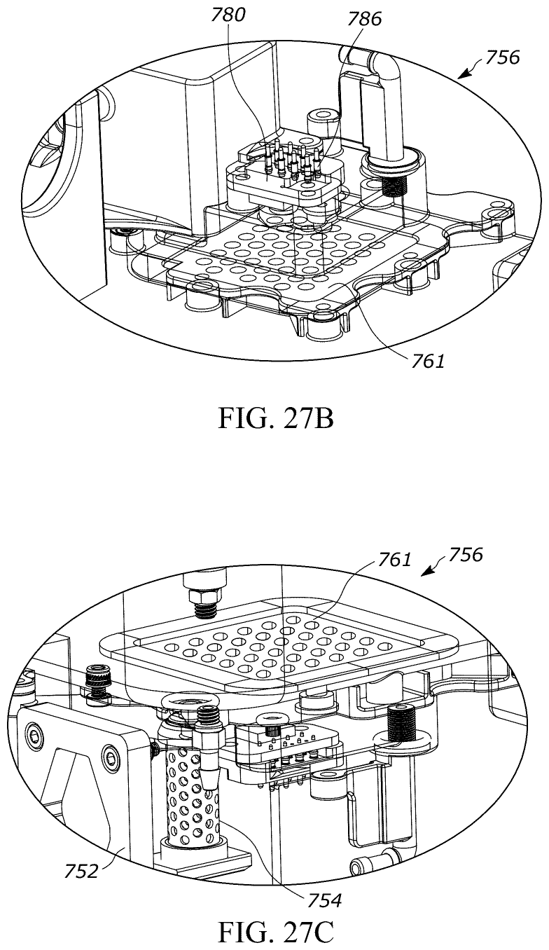

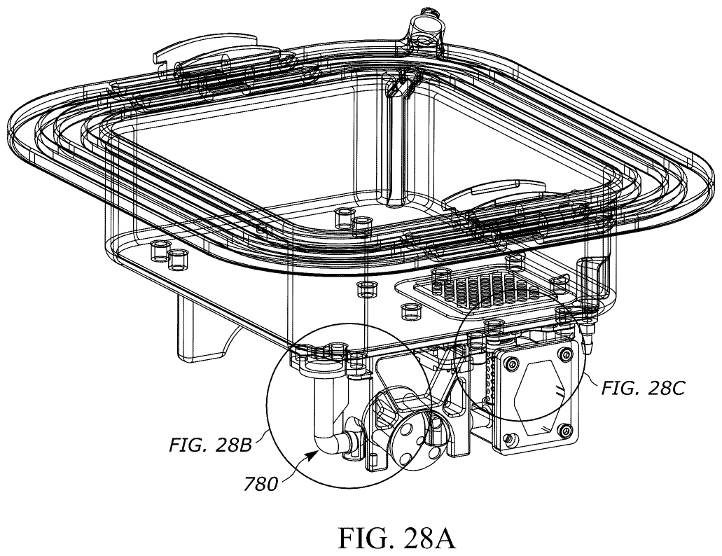

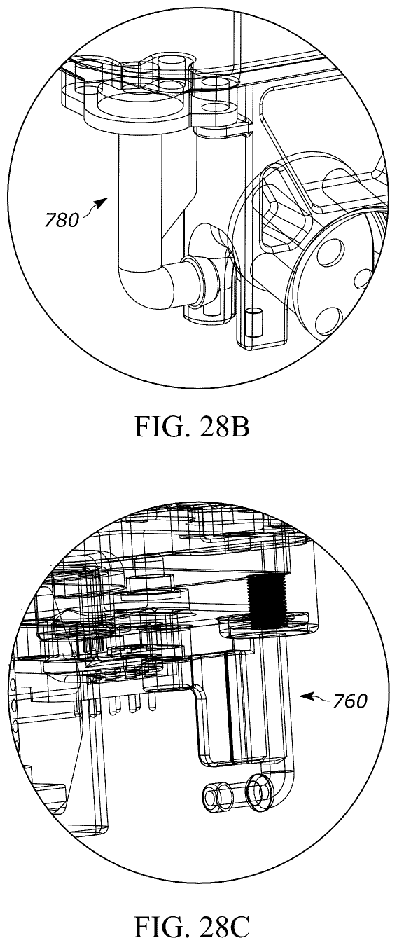

Like the cassette 104, the cassette 704 generally takes the form of a disposable, one-piece cassette that can be easily connected to or disconnected from the portable base 702. However, the cassette 704 is structurally different from the cassette 104. As illustrated in FIGS. 18-36B, the cassette 704 generally includes a chamber sub-assembly 750, an inline pulse dampening element 752 (see FIGS. 24A, 24B, and 25), a perfusate filter 754 (see FIGS. 26A and 26B) disposed downstream of the inline pulse dampening element 752, a bubble trap assembly 756 (see FIGS. 27A-27C), a pump interface 758 (see FIGS. 19-21, 32, and 34), and a fluid line 760 (see FIGS. 28A-28C), each of which form part of a closed perfusion circuit for the device 700 that in use maintains the donor organ during storage and transport. Further details about the pulse dampening element 752, the perfusate filter 754, the bubble trap assembly 756, the pump interface 758, and the fluid line 760 are discussed in U.S. Provisional Application No. 63/827,356, filed Jun. 20, 2025, and titled “Organ Transportation and Perfusion Device and Method,” the entire contents of which are hereby incorporated by reference herein. Some of these details are also repeated below for convenience. For example, and as illustrated in FIGS. 23 and 29-31, the bubble trap assembly 756 includes a hydrophobic filter 761 configured to remove any gas phase material (e.g., air bubbles) from the perfusate flowing through the bubble trap assembly 756.

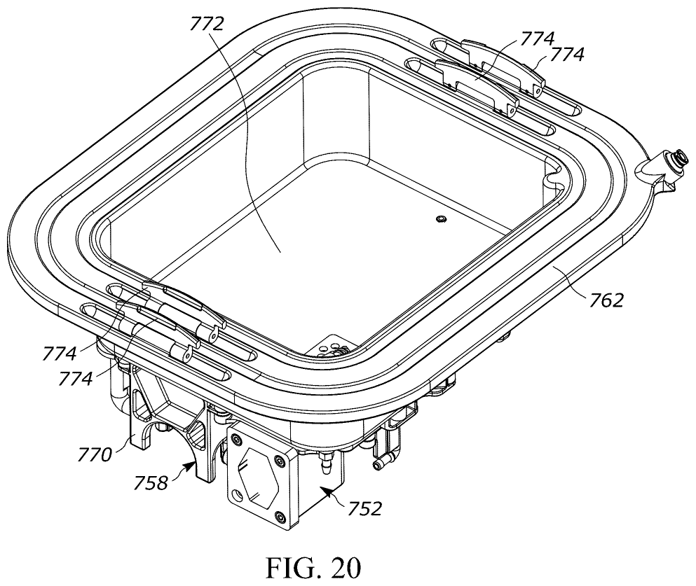

The chamber sub-assembly 750 generally includes a chamber (or cassette) base 762, a first chamber lid 764, a second chamber lid 766, a chamber foot 768, and a perfusion manifold 770 (which may also be referred to as a manifold foot). The chamber base 762 defines the organ supporting chamber 772, which is sized to receive and retain the donor organ to be perfused and transported (e.g., the donor organ 144 discussed above). While not illustrated herein, it will be appreciated that the organ supporting chamber 772 can take the form of or can include any of the organ restraint devices discussed in U.S. Provisional Application No. 63/827,559, filed on Jun. 20, 2025, and titled “Restraint Device for Transportation of Organ for Transplant,” the entire contents of which are hereby incorporated by reference herein. The first chamber lid 764 serves as the inner lid for the organ supporting chamber 772, whereas the second chamber lid 766 serves as the outer lid for the organ supporting chamber 772. When the first and second lids 764, 766 are coupled to the chamber base 762, the first and second lids 764, 766 close or seal the organ supporting chamber 772. In this example, and as illustrated in FIGS. 20-23 and 35, each of the first and second lids 764, 766 is removably coupled to the chamber base 762 via a pair of lid latches 774 and a lid seal 776. The lid seal 776 may, for example, take the form of a silicon rubber seal or a gasket (e.g., a foam gasket).

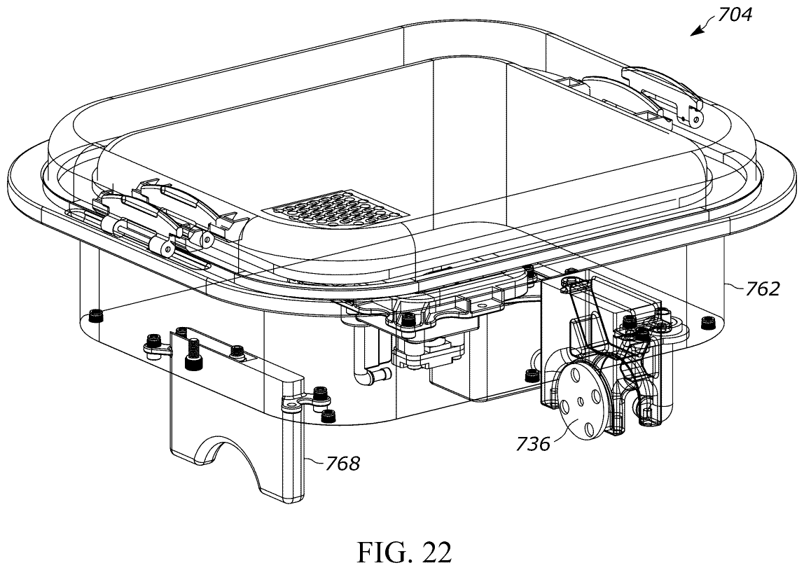

The chamber foot 768 is coupled to and extends outward (downward in FIGS. 18 and 22) from the chamber base 762. More particularly, the chamber foot 768 extends outward from a bottom surface of the chamber 762 at a position immediately adjacent one end of the chamber 762. The perfusion manifold 770 is similarly coupled to and extends outward (downward in FIG. 19) from the chamber base 762, but at a position immediately adjacent the other end of the chamber 762. In other words, the chamber foot 768 and the perfusion manifold 770 are disposed at or immediately adjacent opposite ends of the bottom surface of the base 762. Moreover, it will be appreciated that the pump interface 758 is part of or defined by the manifold 770. In other words, the manifold 770 is configured to receive and engage the pump head 736 via the pump interface 758. Moreover, the manifold 770 also includes a face 782 that is sized to receive and retain tubing (not shown) of the fluid line 760.

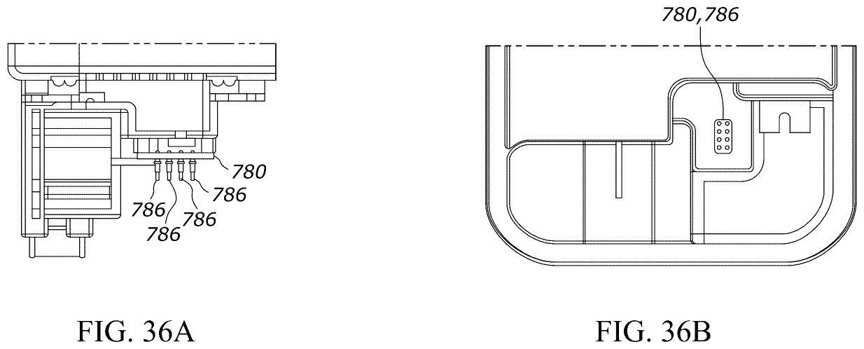

The cassette 704 also includes additional components, namely a drain line 780, a drain port, a sensor board 784, and a plurality of pins 786 disposed on the sensor board 780. The drain line 780 directs organ waste and perfusate from the organ supporting chamber 772 via the drain port and allows the perfusion circuit to be safely emptied. The sensor board 784 is positioned on the bottom surface of the chamber base 762 at a position immediately adjacent the perfusion manifold 770, and the plurality of pins 786 extend outward (downward in FIGS. 27B and 36A) from the sensor board 780. In this example, the pins 786 are pogo pins and the cassette 704 includes eight pins 786, though in other examples, different pins and/or a different number of pins may be employed.

Like the device 100, the device 700 also includes a thermal control system 800. The thermal control system 800 is generally configured to maintain the organ supporting chamber 772 at a pre-determined temperature (or within a range of pre-determined temperatures) that is necessary for the donor organ and the perfusion circuit. Like the thermal control system of the device 100, the thermal control system 800 is a passive cooling system that takes the form of an organ chilling chamber composed of two organ chilling sub-chambers 802. However, unlike the device 100, wherein the thermal control system (in the form of the organ chilling chamber 145) is part of the cassette 104, the cassette 704 of the device 700 does not include the organ chilling chamber. Instead, the organ chilling sub-chambers 802 are separate from the cassette 704. As best illustrated in FIG. 10, the organ chilling sub-chambers 802 are removably disposed between the base 702 and the cassette 704 such that the organ supporting chamber 772 is partially if not entirely surrounded by the organ chilling sub-chambers 802. In turn, the organ chilling sub-chambers 802, which may include or be filled with a coolant, ice, or other substance or may instead take the form of an ice-pack, are configured to cool the organ supporting chamber 772 (and the donor organ disposed therein). At the same time, the organ-chilling sub-chambers 802 can be removed and refilled or replaced as necessary to maintain the organ supporting chamber 772 at the pre-determined temperature (or within the range of pre-determined temperatures). In other examples, it will be appreciated that the thermal control system may instead be an active thermal control system and/or the thermal control system may be a heating system. For example, the thermal control system can instead include a heat exchanger.

Operation of the device 700 generally begins when the cassette 704 engages the base 702 (and the components of the cassette interface 708 at least partially defined by the base 702). More particularly, operation of the device 700 begins when the chamber foot 768 and the perfusion manifold 770 are aligned with and then disposed in the foot pocket 742 and the manifold pocket 740, respectively. In this example, the necessary engagement occurs responsive to action by the user, when, for example, the user places or drops the cassette 704 so that the chamber foot 768 and the perfusion manifold 770 are disposed in the foot pocket 742 and the manifold pocket 740, respectively. Responsive to this engagement, the components of the cassette 704 are automatically mechanically, thermally, and electrically connected to the components of the base 702. For example, the pump head 736 is automatically connected to the pump race 780 of the manifold 770, the plurality of pins 786 are disposed in a plurality of receptacles respectively formed in the electronics interface 734. In turn, the perfusion circuit is closed and the device 700 is fully operational.

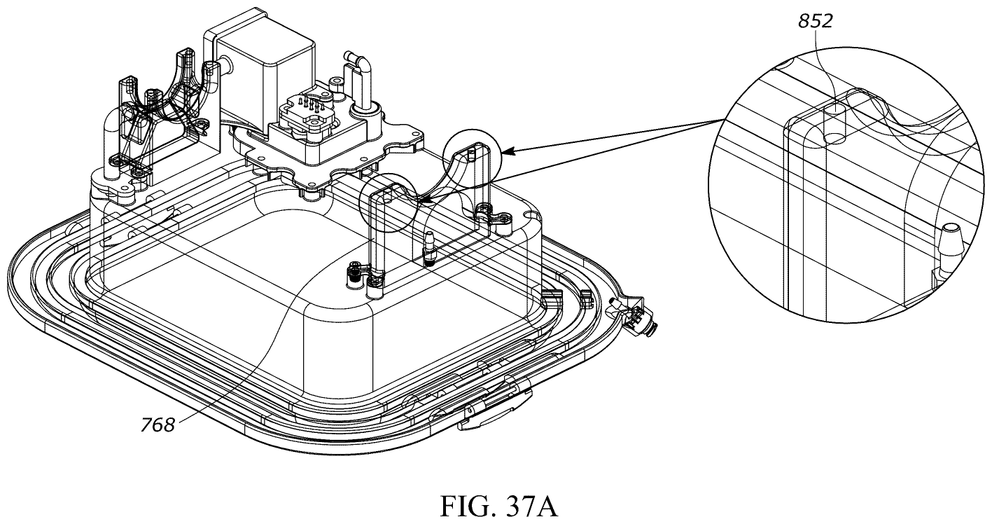

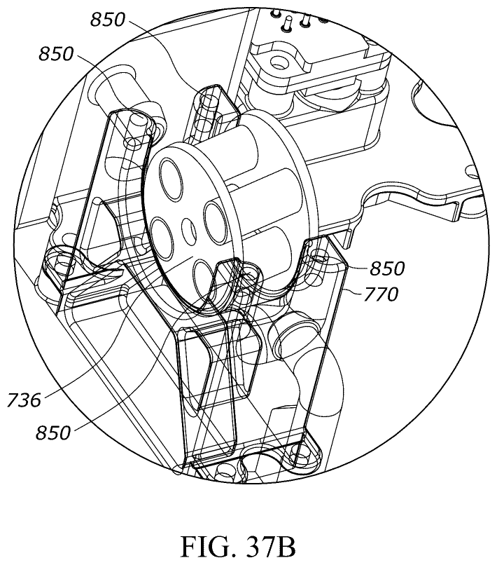

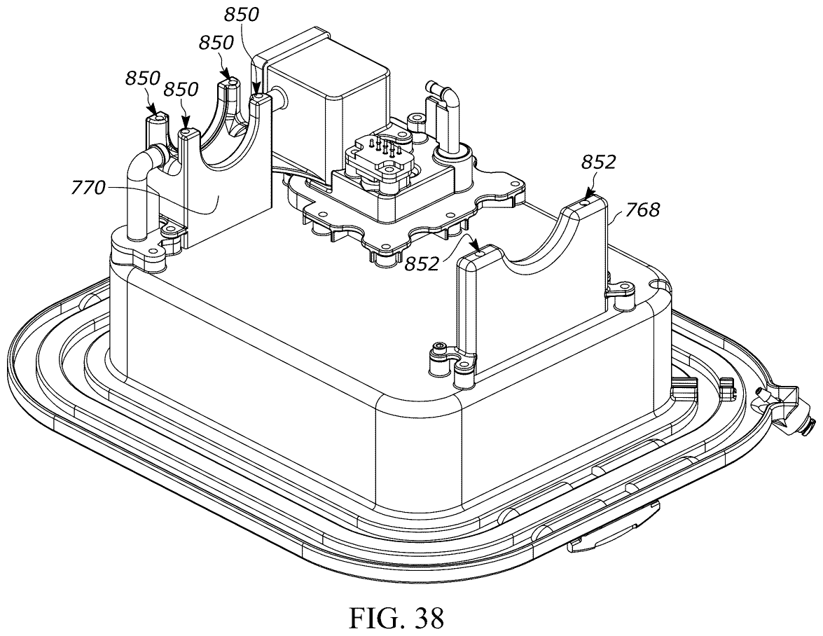

Optionally, the cassette 704 can be removably retained in this position using a plurality of magnets. For example, and as illustrated in FIGS. 37A, 37B, and 38, the cassette 704 may include one or more first magnets 850 that are disposed on the manifold 770 and magnetically interact with one or more corresponding first magnets (not shown) disposed in the manifold pocket 740 when the manifold 770 is disposed in the manifold pocket 740. Alternatively or additionally, and as also illustrated in FIGS. 37A, 37B, and 38, the cassette 704 may include one or more second magnets 852 that are disposed on the foot 768 and magnetically interact with one or more corresponding second magnets (not shown) disposed in the foot pocket 742 when the chamber foot 768 is disposed in the foot pocket 742.

The perfusate described herein can include blood or a medical fluid (e.g., a synthetic medical fluid) and may include an oxygen carrier. The medical fluid may contain antioxidants to reduce peroxidation or presence of and damage due to free radicals in the tissue. The perfusate is configured to prevent washing of or damage to the endothelial lining within the organ arteries. As an example, when using two perfusates, one perfusate may be oxygenated, while the other is not oxygenated. The perfusion may contain a vasodilator, designed to increase capillary perfusion and reduce capillary resistance. Examples of perfusates are further disclosed in the '769 Patent discussed above.

1. The apparatus of claim 2, further comprising:
a pump connected to the cassette interface;
wherein responsive to the cassette engaging the cassette interface, the cassette is automatically connected to the pump via the cassette interface and the apparatus is fully operational.

2. An apparatus for perfusing and transporting an organ for transplant, the apparatus comprising:
a base comprising a plurality of electrical components, the plurality of electrical components including one or more sensors;
a cassette removably connectable to the base, the cassette including an organ supporting chamber adapted to sterilely store and transport the organ;
a cassette interface; and
wherein responsive to the cassette engaging the cassette interface, the cassette is automatically connected to the electrical components via the cassette interface and the apparatus is fully operational.

3. The apparatus of claim 2, the pump including a pump head and a drive motor for the pump head, wherein responsive to the cassette engaging the cassette interface, the cassette is automatically connected to the drive motor via the cassette interface.

4. The apparatus of claim 3, wherein the pump head is carried by the base.

5. The apparatus of claim 3, wherein the pump head is carried by the cassette.

6. The apparatus of claim 2, wherein the one or more sensors comprise a bubble sensor, and wherein responsive to the cassette engaging the cassette interface, the cassette is automatically connected to the bubble sensor via the cassette interface.

7. An apparatus for perfusing and transporting an organ for transplant, the apparatus comprising:
a base;
a cassette removably connectable to the base, the cassette including an organ supporting chamber adapted to sterilely store and transport the organ;
a cassette interface; and
a pump, the pump including a pump head and a drive motor for the pump head, wherein responsive to the cassette engaging the cassette interface, the cassette is automatically connected to the drive motor via the cassette interface.

8. The apparatus of claim 7, wherein the pump head is carried by the base.

9. The apparatus of claim 7, wherein the pump head is carried by the cassette.

10. The apparatus of claim 7, further comprising a thermal control system configured to maintain the organ supporting chamber at a pre-determined temperature or within a pre-determined range of temperatures.

11. (canceled)

12. The apparatus of claim 10, wherein the thermal control system comprises an organ chilling chamber disposed immediately adjacent the organ supporting chamber.

13. (canceled)

14. The apparatus of claim 7, further comprising a lid removably coupled to the portable base to securely connect the cassette to the portable base.

15. (canceled)

16. The apparatus of claim 14, wherein the lid comprises an outer shell, an inner shell, and an insulation stack disposed between the outer shell and the inner shell, wherein the inner shell at least partially surrounds the portable base.

17. (canceled)

18. (canceled)

19. (canceled)

20. The apparatus of claim 14, further comprising a single handle rotatably coupled to the lid, wherein the single handle is rotatable between a first position, in which the single handle surrounds a portion of the lid, and a second position, in which a portion of the single handle is spaced from the lid.

21. The apparatus of claim 20, wherein the portable base includes a primary user interface, wherein when the lid is coupled to the portable base, the primary user interface is hidden from view, and wherein when the lid is removed from the portable base, the user interface is visible.

22. The apparatus of claim 21, wherein the user interface is configured to output one or more alarms only when the lid is removed from the portable base.

23. (canceled)

24. (canceled)

25. (canceled)

26. (canceled)

27. (canceled)

28. The apparatus of claim 12, wherein the cassette includes the organ chilling chamber.

29. The apparatus of claim 12, wherein the organ chilling chamber is removably coupled to the portable base and the cassette.

30. The apparatus of claim 28, wherein the organ supporting chamber is surrounded by the organ chilling chamber.

31. (canceled)

32. The apparatus of claim 7, wherein the cassette interface comprises a manifold pocket coupled to the portable base, and wherein the cassette includes a manifold configured to be removably disposed in the manifold pocket.

33. (canceled)

34. The apparatus of claim 32, wherein the pump is partially disposed in the manifold pocket, and wherein the manifold of the cassette engages the pump when the manifold is disposed in the manifold pocket.

35. The apparatus of claim 34, wherein the pump comprises a pump head and a drive motor configured to drive the pump head, wherein the pump head is disposed in the manifold pocket and the drive motor is coupled to the portable base and disposed outside of the manifold pocket.

36. The apparatus of claim 32, wherein the cassette interface comprises a foot pocket coupled to the portable base, and wherein the cassette includes a foot configured to be removably disposed in the foot pocket.

37. (canceled)

38. (canceled)

39. The apparatus claim 7, further comprising a perfusion circuit configured to maintain the organ, the perfusion circuit including a fluid line and a bubble trap assembly disposed in the fluid line.

40.-58. (canceled)
